(19) United States
(12) Patent Application Publication
(10) Pub. No.: US 2026/0004529 A1
(43) Pub. Date: Jan. 1, 2026

(54) METHOD AND SYSTEM

(71) Applicant: COVER Corp., Tokyo (JP)

(72) Inventor: Kohei MORI, Tokyo (JP)

(21) Appl. No.: 19/322,675

(22) Filed: Sep. 9, 2025

Related U.S. Application Data
(63) Continuation of application No. PCT/JP2024/005184, filed on Feb. 15, 2024.

(30) Foreign Application Priority Data
Mar. 10, 2023 (JP) 2023-038081

(51) Int. Cl. G06T 19/00

(52) U.S. Cl. CPC G06T 19/00; G06T 2219/024

(57) ABSTRACT

When a user performs an operation on their user terminal to designate another user as a mute target, then the distribution server receives mute designation information transmitted from the user terminal. Then, the mute received history is updated for the designated other user. If a comment is posted from a user who is one of a plurality of users participating in the virtual space of the same content and who meets the restriction condition based on the mute received history, and for whom a full mute flag is are set to ON, the posting user is considered to be a user who tends to make nuisance comments, and the reflection of the comment from the posting user is restricted on the user terminals of a plurality of users participating in the virtual space, including a user who has not designated the user as a mute target.

### CROSS-REFERENCE TO RELATED APPLICATIONS

This application claims the benefit of priority and is a Continuation application of the prior International Patent Application No. PCT/JP2024/005184, with an international filing date of Feb. 15, 2024, which designated the United States, and is related to the Japanese Patent Application No. 2023-038081, filed Mar. 10, 2023, the entire disclosures of all applications are expressly incorporated by reference in their entirety herein.

### BACKGROUND

### 1. Technical Field

The present invention relates to methods and systems.

### 2. Description of the Background

Some conventional systems allow users of a group to share comments and other information posted in the group, and are configured to, after receiving a designation not to display a comment from a user (hereinafter referred to as a first user) in the group from another user (herein referred to as a second user), hide the comments from the first user on the terminal of the second user who made the request (see, for example, Patent Literature 1).

### CITATION LIST

### Patent Literature

Patent Literature 1: JP 2017-91065 A

### BRIEF SUMMARY

Unsolicited posts that are designated to hide tend to be repeated by malicious users. In conventional systems, however, comments posted by a malicious user who repeatedly posts unsolicited content are displayed unless a user designates to hide the comments. On the other hand, if accepting a designation from any user to make comments posted by a designated user invisible for all the users in the group, such a designation would be made maliciously to deprive the right of the designated user to post a comment (to frame up the user), or excessive restriction may hinder free interaction and communication in the group.

In view of the above, the present invention provides a method and a system that are capable of efficiently restricting harassment without impeding free interaction and communication.

(1) A method that makes a computer execute to allow an action (e.g., comments, and behavior) received from a plurality of user terminals operated by a plurality of users who have a specific relationship (e.g., users who participate in a virtual space of the same content, and users whose user characters exist within a predetermined range) to be reflected on the user terminals so that each user is able to recognize the action, the method comprising:
receiving restriction information (e.g., mute designation information) for designating (e.g., mute-designation) a specific user as a restriction target user from a user terminal, thereby updating a restriction history on the specific user (e.g., step S81 of FIG. 16); and
when an action is received from a user terminal operated by a user (e.g., a user whose full mute flag is set to ON) who meets a restriction condition on a basis of the restriction history, among the plurality of user terminals operated by the plurality of users having the specific relationship, performing a process to enable restriction of reflection of the action on the plurality of user terminals, including a user terminal operated by a user who has not designated the user who meets the restriction condition as a restriction target user (e.g., if the determination is YES in step S91, step S92, step S94 and others, steps S97 and S98 are not executed).

If a user is designated as a restriction target and so their restriction history is updated to meet the restriction condition, this configuration considers such a user tends to perform nuisance actions, and enables restricting the reflection of an action from the user who meets the restriction condition on the user terminals of a plurality of users who have a specific relationship, including a user who has not designated them as a restriction target user. This allows for efficient restriction of harassment and other activities without interfering with free exchange and communication.

(2) In the above (1), the performing a process to enable restriction includes not reflecting the action from the user who meets the restriction condition on the plurality of user terminals (e.g., NO in step S99 of FIG. 17).

This configuration does not reflect an action from a user who meets the restriction condition based on their restriction history, thus preventing the action from the user who tends to perform nuisance actions from being reflected and thus adversely affecting other users.

(3) In the above (1), the performing a process to enable restriction includes not reflecting the action from the user who meets the restriction condition on the plurality of user terminals in accordance with a predetermined ratio.

This configuration thins out the reflection of actions from a user who meets the restriction condition based on their restriction history, thus preventing all of the actions from the user who tends to perform nuisance actions from being reflected and thus adversely affecting other users.

(4) In the above (3), the action that is a target of the process of not reflecting on the plurality of user terminals in accordance with a predetermined ratio includes a predetermined identical action that is received from the user who meets the restriction condition consecutively over a predetermined period of time.

This configuration prevents other users from feeling uncomfortable due to the same actions being performed consecutively over a predetermined period of time.

(5) In the above (1), the method further comprises:
in accordance with information (e.g., full mute selection information) from a user terminal for setting whether to restrict reflection of an action from a user who meets the restriction condition, storing setting information (e.g., full mute off flag) in a storage unit, the setting information corresponding to a user of the user terminal and being for specifying whether to restrict reflection of an action from the user who meets the restriction condition (e.g., step S84 of FIG. 16), wherein
the performing a process to enable restriction includes, when an action is received from a user terminal operated by a user who meets the restriction condition, performing a process to enable restricting reflection of the action on a user terminal operated by a user who has specified to restrict reflection of an action from the user who meets the restriction condition in accordance with the setting information stored in the storage unit (e.g., NO in step S99 of FIG. 17).

This configuration allows restriction on the reflection of an action from a user who meets the restriction condition to be set for each user, thereby improving the user's convenience.

(6) In the above (1), whether or not to meet the restriction condition is determined on a basis of a restriction history that is updated for a predetermined period (e.g., a first period and a second period) in the updating.

This configuration prevents unnecessary restrictions of an action, which may happen if the history in the past before a predetermined period is taken into account and thus the user is still determined to meet the restriction condition, even if they have changed their attitudes and improved their actions.

(7) In the above (6), the predetermined period includes a first period (e.g., 24 hours) and a second period (e.g., one week) that is longer than the first period, and
the restriction condition is met on a basis of the restriction history when the number of times restriction information is received within the first period reaches a first number, and is also met when the number of times restriction information is received within the second period reaches a second number that is greater than the first number even if the number of times restriction information is received within the first period has not reached the first number (e.g., see FIG. 15).

This configuration allows for appropriate restriction because the period of time for the determination of whether or not the restriction condition is met and the number of times the user receives restriction information are defined in a stepwise manner.

(8) In the above (7), the second period is twice or longer than the first period, and
the second number is a number less than twice the first number (e.g., see FIG. 15).

With this configuration, the second number used for the determination whether to meet the restriction condition within the second period is less than twice the first number used for the determination whether to meet the restriction condition within the first period. This allows, even if a user is designated as a restriction target to the extent that they are not determined to meet the restriction condition in the first period, the user to be determined to meet the restriction condition when viewed over the longer second period of time, and thus the user may be restricted. This restricts the reflection of an action from a user who are routinely designated as a restriction target user over a long period of time.

(9) In the above (1), the updating includes, from a user who has transmitted restriction information for designating a specific user as a restriction target user, receiving cancellation information for cancelling the designation of the specific user as a restriction target user (e.g., mute cancellation information), thus updating a restriction history on the specific user (e.g., step S81 of FIG. 16),
the performing a process to enable restriction includes
determining whether a restriction condition is met on a basis of the restriction history (e.g., step S92 through step S95 of FIG. 17), and
the determining includes
when receiving cancellation information on a user who has been determined to meet the restriction condition on a basis of the restriction history, and also when the restriction history is updated so as not to meet the restriction condition, keeping a determination that the user who has been determined to meet the restriction condition still meets the restriction condition (e.g., even if the determination is YES in step S83 of FIG. 16, the full mute flag is not set to OFF).

This configuration allows the determination that the user meets the restriction condition to be kept even after receiving the cancellation information, and thus prevents unauthorized cancellation of the restriction condition by the user operation.

(10) In the above (1), the method further comprises:
when a cancellation condition on a user, the user being a restriction target by the performing a process to enable restriction, is met (e.g., YES in step S87 of FIG. 16), cancelling restriction by the performing a process to enable restriction on the user (e.g., step S88 of FIG. 16),
the updating includes updating a cancellation history (e.g., full mute history) on the user whose restriction has been cancelled in the cancelling, and
a criterion for determining whether the restriction condition is met varies in accordance with a cancellation history of each user.

This configuration allows the criterion for determining whether the restriction condition is met to be varied depending on the cancellation history. This allows the degree of restrictions to be adjusted depending on the cancellation history. For instance, the more the cancellation history is, the user may be determined to meet the restriction condition with the fewer number of times a user is designated as a restriction target user.

(11) In the above (10), the method further comprises:
updating an action history for specifying an action (e.g., total comment history) received from a user terminal for each user (e.g., log management unit 131); and
notifying the action history so that the action history is visible to an operator (e.g., step S86 of FIG. 16).

This configuration allows the operator to keep track of the action history.

(12) In the above (1), the updating includes receiving the restriction information, and thus updating a transmission history (e.g., designation frequency) of the restriction information from the user who has transmitted the restriction information, and
whether or not the restriction condition is met is determined on a basis of a transmission history of the user who has designated a specific user as a restriction target user (e.g., the designation frequency of the mute designation user is the number of mutes).

This allows for a stronger or weaker influence on a designation as a restriction target user, depending on the transmission history.

(13) In the above (1), the method further comprises:
displaying specifying information (e.g., user characters) that enables specification of a plurality of users having the specific relationship, and also enabling display of specifying information that enables specification of a user who meets the restriction condition.

This configuration displays specific information that enables specification of a user who satisfies the restriction condition. It thus makes it difficult for the user who meets the restriction condition to find that they meet the restriction condition and the reflection of their actions is restricted.

(14) In the above (1), the performing a process to enable restriction includes, when an action is received from a user terminal operated by any special user (e.g., a full mute excluded user, such as a SP user) belonging to a special type, performing a process to enable reflection of the action on a user terminal operated by a user who has not designated the special user among a plurality of users having the specific relationship as a restriction target user, regardless of a restriction history on the special user, and performing a process to enable restricting reflection of the action on a user terminal operated by a user who has designated the special user as a restriction target user (e.g., step S96 through step S98 of FIG. 17).

This configuration restricts the reflection of an action even from a special user on the user terminal of the user who has designated the special user as a restriction target user, and thus respects the user's intention and prevents any adverse effects on that user.

(15) In the above (1), the performing a process to enable restriction includes, when a restriction target action that is set as an action to restrict reflection is received, performing a process to enable restricting reflection of the action on a plurality of user terminals operated by a plurality of users having the specific relationship, regardless of a restriction history on the user who has performed the action (e.g., FIG. 8 through FIG. 13H), and
even when the restriction target action is received, the updating does not include updating the restriction history on the user who has performed the restricted action (e.g., step S81 of FIG. 16).

This configuration enables the separate management between restriction target actions and a restriction history, preventing one from affecting the other and resulting in excessive restrictions.

(16) In the above (1), the specific relationship is a relationship associated with a common group (e.g., see FIG. 6A to FIG. 6C), and
the updating includes receiving restriction information from a user in the common group, and thereby updating a restriction history in the group on a specific user designated by the restriction information.

This configuration allows the restriction history of a specific user designated by restriction information from a user associated with the common group to be instantly updated, and also prevents a comment from the specific user from being reflected on the user terminal of the user who designated the specific user as a restriction target. Furthermore, this configuration determines whether or not the restriction condition is met for users associated with the common group, thereby increasing the effectiveness of the restriction.

(17) In the above (1), the updating is performed so that information specifying a user who has designated a restriction target user and information specifying a user designated as a restriction target, both pieces of the information being on a basis of the updated restriction history, are set unidentifiable for the plurality of users.

This configuration prevents users from specifying the information and abusing it (e.g., designating a specific user as a user to be restricted by multiple users and thus having the user meet the restriction condition by targeting the specific user).

(18) A system that comprises a computer and allows an action (e.g., comments, and behavior) received from a plurality of user terminals operated by a plurality of users who have a specific relationship (e.g., users who participate in a virtual space of the same content, and users whose user characters exist within a predetermined range) to be reflected on the plurality of user terminals so that each user is able to recognize the action, the computer performing a process comprising:
receiving restriction information (e.g., mute designation information) for designating (e.g., mute-designation) a specific user as a restriction target user from a user terminal, thereby updating a restriction history on the specific user (e.g., step S81 of FIG. 16); and
when an action is received from a user terminal operated by a user (e.g., a user whose full mute flag is set to ON) who meets a restriction condition on a basis of the restriction history, among the plurality of user terminals operated by the plurality of users having the specific relationship, performing a process to enable restriction of reflection of the action on the plurality of user terminals, including a user terminal operated by a user who has not designated the user who meets the restriction condition as a restriction target user (e.g., if the determination is YES in step S91, step S92, step S94 and others, steps S97 and S98 are not executed).

If a user is designated as a restriction target and so their restriction history is updated to meet the restriction condition, this configuration considers such a user tends to perform nuisance actions, and enables restricting the reflection of an action from the user who meets the restriction condition on the user terminals of a plurality of users who have a specific relationship, including a user who has not designated them as a restriction target user. This allows for efficient restriction of harassment and other activities without interfering with free exchange and communication.

### BRIEF DESCRIPTION OF DRAWINGS

FIG. 1 shows an example of a hardware configuration of a communication system.

FIG. 2 describes the configuration of a distribution server.

FIG. 3 describes the configuration of an administrator terminal.

FIG. 4 describes the configuration of a user terminal (user terminal and distribution user terminal) in detail.

FIG. 5 describes an example of the types of content provided by the distribution server.

FIG. 6A, FIG. 6B, and FIG. 6C describe one example of the log information stored in the storage unit of the distribution server.

FIG. 7A, FIG. 7B, and FIG. 7C describe one example of the NG information stored in the storage unit of the distribution server.

FIG. 8 is a flowchart of the comment control process during distribution of a first mode of content.

FIG. 9A, FIG. 9B, FIG. 9C, FIG. 9D, FIG. 9E and FIG. 9F illustrate display examples of a user terminal during distribution of a first mode of content.

FIG. 10 is a flowchart of the comment control process during distribution of a second mode of content.

FIG. 11A, FIG. 11B, FIG. 11C, FIG. 11D, FIG. 11E, and FIG. 11F illustrate display examples of a user terminal during distribution of a second mode of content.

FIG. 12 is a flowchart of the comment control process during distribution of a third mode of content.

FIG. 13A, FIG. 13B, FIG. 13C, FIG. 13D, FIG. 13E, FIG. 13F, FIG. 13G, and FIG. 13H illustrate display examples of a user terminal during distribution of a third mode of content.

FIG. 14 describes one example of the mute related information stored in the storage unit of the distribution server.

FIG. 15 describes one example of restriction conditions in the mute related information stored in the storage unit of the distribution server.

FIG. 16 is a flowchart of a mute related information update process for updating the mute related information.

FIG. 17 is a flowchart of the comment distributing process.

### DETAILED DESCRIPTION

The following describes embodiments of a communication system according to the present invention, with reference to the drawings. The present invention is not limited to the following examples, and is defined by the claims. All modifications within the meaning and scope equivalent to the claims are intended to be included in the present invention. In the following descriptions, like reference numerals designate like parts throughout the descriptions of drawings to omit their duplicated descriptions.

### First Embodiment

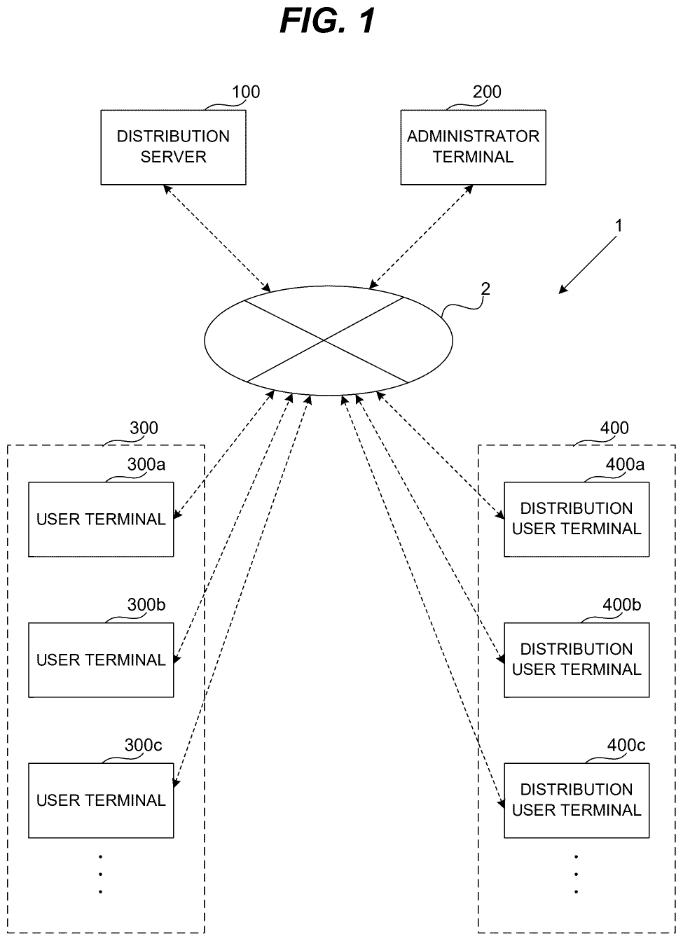

FIG. 1 shows an example of a hardware configuration of a communication system 1. The communication system 1 includes a distribution server 100, an administrator terminal 200, a plurality of user terminals 300a, 300b, 300c . . . , and a plurality of distribution user terminals 400a, 400b, 400c . . . . Each of the plurality of user terminals 300a, 300b, 300c, . . . is owned by one of a plurality of users, and they are hereinafter collectively referred to as a user terminal 300. Each of the plurality of distribution user terminals 400a, 400b, 400c, . . . is owned by one of a plurality of distribution users who are able to distribute content initiatively, and they are hereinafter collectively referred to as a distribution user terminal 400. Both the user terminal 300 and the distribution user terminal 400 are used by a user. Thus they will hereinafter be referred to collectively as user terminals.

The distribution server 100, the administrator terminal 200, the user terminals 300, and the distribution user terminals 400 are connectable for communication via a network 2, and are able to transmit and receive information (data) in both directions. The network 2 is the internet, for example, and includes local area network (LAN), wide area network (WAN), mobile communication network (e.g., 5G and wireless network), wired telephone network, fiber to the home (FTTH), cable television (CATV) network, and other access networks.

For instance, the distribution server 100 is a computer such as a workstation or a personal computer having a communication function. The distribution server 100 manages multiple virtual spaces, which are virtual worlds constructed over a computer, and provides services (content) using the virtual space selected by a user via the network 2.

The users in this embodiment include general consumers, performers and celebrities. For instance, performers include talented people from various genres, such as performers belonging to service providers (operating companies), entertainers, actors, comedians, multi-talented people, emcees, anchorpersons, singers, musicians, and models. For instance, celebrities include famous company executives or employees, athletes, e-sports players, famous scholars and cultured persons, cram school tutors, famous students, and other famous people of various genres.

A virtual space is managed and set up for each type of content offered. The content that can be offered includes, but is not limited to, content that allows users to watch or experience games, live performances, live events, programs, and others, and content that allows users to interact and communicate with each other using chats and emotes. A user accesses the distribution server 100 using the user terminal 300 or the distribution user terminal 400 and selects desired content, thereby seamlessly participating in (navigating) the content and being able to view and experience the virtual space corresponding to the content.

Depending on the type of content, a virtual space may include a three-dimensional space (space constructed on the basis of three-dimensional data) generated by computer graphics (CG) or a two-dimensional space (space constructed on the basis of two-dimensional data). The virtual space also provides a virtual character (avatar object), an object showing backgrounds and virtual objects according to the type of content, a menu object selectable by the user, and others. The virtual character placed in the virtual space includes a user character that is preset corresponding to each user participating in the virtual space and is operable in response to operations from the user, and a non-player character that operates according to a program.

An object to be placed in the virtual space includes: for game content, a character object corresponding to the game, and a user character of a user playing the game content that are placed on a field object corresponding to the game field; and for live event content, a stage object, an audience seat object and a lighting object, a user character of the performer performing as the emcee of the live performance on the stage object, and user characters of participating users that are placed on the audience seat object. For content that lets users communicate with each other, the objects placed include a user character for each of the multiple users participating and an item object that can be used for communication.

The distribution server 100 stores, in its storage unit 120, information for displaying images in a plurality of virtual spaces corresponding to the distributable content on a user terminal, and sound information for outputting sound. In response to an access from a user terminal, the distribution server 100 distributes content data that includes display information for displaying images in the virtual space of the corresponding content and sound information for outputting sound, thus providing the content (service) to the user.

For instance, the content data includes: information for specifying information relating to an object placed within the virtual space (e.g., the type of object, placement position, orientation, posture, and appearance); information relating to the user character of each user participating in the virtual space (e.g., the type of user character, placement position, orientation, posture, appearance, motion data, and audio data); an object indicating backgrounds or virtual objects according to the type of content; and information for specifying menu objects selected by the user.

An object in the virtual space may change in the posture, position, expression, and others in response to operations through a user terminal, and the appearance of an object placed may change over time. Therefore, the content data is distributed at predetermined intervals (e.g., every 0.016 seconds, which is about 60 fps), enabling images in the virtual space that change from moment to moment to be displayed on the user terminal.

The administrator terminal 200 is used by an operator of a service provider, for example. For instance, the administrator terminal 200 is a computer with operation input and communication functions, such as a personal computer. The operator creates, configures, modifies, and updates the content and images in the virtual space to be managed in the storage unit 120 of the distribution server 100 via the administrator terminal 200. For instance, the operator creates and configures new content and images in a virtual space, and changes and modifies existing content and images in a virtual space. The operator also sets and updates the information to be managed in the storage unit 120 of the distribution server 100 via the administrator terminal 200.

In this embodiment, the distribution server 100 and the administrator terminal 200 are each independent computer (apparatus). In another embodiment, they may be implemented by one computer, or the functions of one of these computers (e.g., the distribution server 100) may be implemented by multiple computers (e.g., multiple servers).

The user terminal 300 is used by a user who views and experiences content. For instance, the user terminal 300 may be a computer with operation input and communication functions, such as a personal computer, a tablet terminal, and a smartphone. Like the distribution user terminal 400 described later, the user terminal 300 may have a motion capture function to capture user actions.

The user terminal 300 communicates with the distribution server 100 in response to an operation with the terminal to receive content data of the content selected by the user. The user terminal 300 configures, in the storage area of the user terminal 300, a virtual space for the content selected by the user from among the virtual spaces configured in the distribution server 100 on the basis of the received content data, and displays images in the virtual space and outputs sound. This allows the user to view and experience the virtual space of the content via the user terminal 300.

The user terminal 300 also accepts operations on the displayed virtual space and objects. The user terminal 300 transmits information in accordance with the operation with the terminal to the distribution server 100 to operate and move their user character within the virtual space of the content in which the user is participating. The movement of the user character, for example, may be reflected (synchronized) also in the virtual space at each of the user terminals 300 of users participating in the same content, on the basis of the content data transmitted from the distribution server 100 at predetermined time intervals as described above.

While the user terminal 300 enables the user to view and experience the virtual space of content, it also allows the user to post a comment including any message that is an example of action for the virtual space of content where the user is participating in response to an operation with the user terminal. After posting of the comment, such a comment may be reflected on each user terminal 300 so that the users participating in the content are allowed to check such a comment.

The distribution user terminal 400 is used by a distribution user who is able to distribute content. In addition to the operation input and communication functions, the distribution user terminal 400 has a motion capture function to capture the actions of a distribution user (e.g., a head-mounted device (HMD), a device equipped with an image capturing device to analyze user actions from images of the user taken by the image capturing device). In this case, the user wears the HMD on the head, for example, and holds a controller that is communicable with the HMD with a hand. Then, when the user moves the head or hand or operates buttons of the controller, this enables the operation of the displayed virtual space and virtual characters.

The distribution user terminal 400 may acquire motion information to identify the head or hand movements of the distribution user and controller operations, and audio information to identify the voice of the distribution user, and transmit it to the distribution server 100 to reflect the user character's movements and voice in the participating virtual space. This allows the distribution user terminal to operate the user character of the distribution user in the virtual space as if it were the avatar of the user. The movement and voice of the user character, for example, may be reflected (synchronized) in the virtual space at each of the user terminals 300 of users (including the distribution user) participating in the virtual space, on the basis of the content data transmitted from the distribution server 100 at predetermined time intervals as described above.

Note that the distribution user may be a general user (just a viewer or participant) who views or experiences the distributed content using the user terminal 300 with the same configuration as the distribution user terminal 400, or may be a general user using the user terminal 300 with a configuration different from the distribution user terminal 400. The distribution user terminal 400 and the user terminal 300 may be terminals having the same configuration or may be terminals having different configurations. A distribution user may participate in a virtual space as a distributor who distributes content, or as a general user (just a viewer/participant), not as a distributor. Therefore, a distribution user is included in users. A distribution user is allowed to select or change which position they are in, for example, at a specific timing (e.g., when logging in, when starting content distribution, when displaying the user character of the distribution user in the content to be distributed).

### <Configuration of Distribution Server>

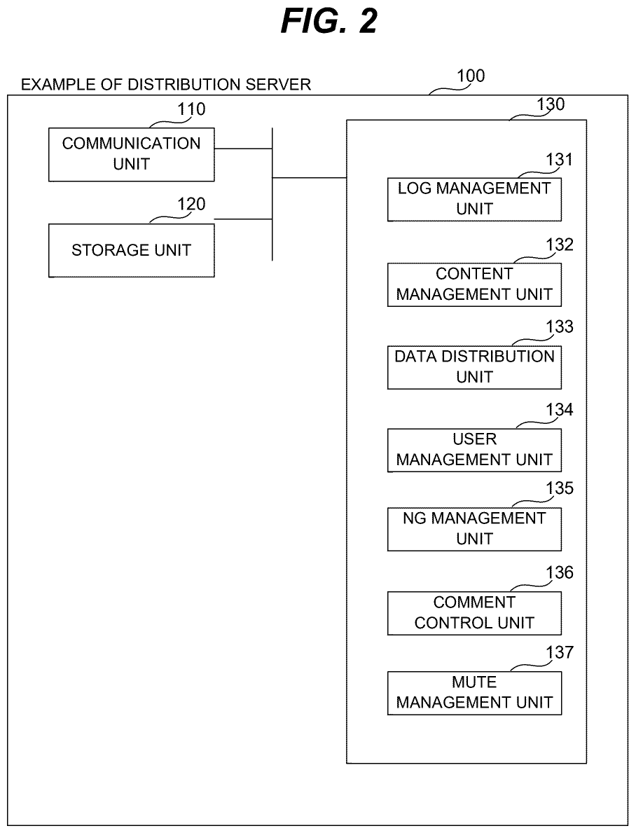

Next the following describes the configuration of the distribution server 100. As shown in FIG. 2, the distribution server 100 includes a communication unit 110 that communicates with other computers, a storage unit 120 that stores various data, and a controller 130 that controls the entire computer. These communication unit 110, storage unit 120, and controller 130 are connected to each other by a bus line.

The communication unit 110 is a communication interface including a network interface card controller (NIC) for performing wired or wireless communication. The communication unit 110 communicates with other computers via the network 2.

The storage unit 120 includes a random access memory (RAM), a read only memory (ROM), a flash memory or a hard disk drive (HDD). The storage unit 120 stores programs for executing various control processes (e.g., programs for managing and providing content using a virtual space), various data, and others. The various data stored in the storage unit 120 includes information for specifying an image of a virtual space provided for each type of content, user information relating to a user, NG information (in this description, the term NG represents No Good that is taboo or inappropriate) relating to a NG word, log information relating to an access from a user, and a mute related information relating to mute.

The controller 130 includes a central processing unit (CPU). The controller 130 executes a program stored in the storage unit 120 to control the overall operation of the distribution server 100.

The following describes a functional configuration of the controller 130. The controller 130 functions as at least a log management unit 131, a content management unit 132, a data distribution unit 133, a user management unit 134, a NG management unit 135, a comment control unit 136, and a mute management unit 137.

In response to access from a user terminal, the log management unit 131 stores log information in the storage unit 120, and the log information includes: participating user information for identifying users participating in each content/virtual space; related user information for identifying related users who are associated with the content, such as those who initiatively distribute the content; and action information (comment history, described below) for specifying the action history of users in the virtual space (e.g., the content of posted comments and the history of users who posted the comments).

The content management unit 132 stores and updates, via the communication unit 110, information for specifying an image in a virtual space corresponding to the content set by the administrator terminal 200 in the storage unit 120. The content management unit 132 stores in the storage unit 120: information for specifying the type of content set by the administrator terminal 200; information for specifying an image in the virtual space for each piece of content; and information for specifying the date and time of distribution for content to be distributed at a predetermined date and time, for example. The information for specifying an image in the virtual space includes information on objects placed in the virtual space, user characters corresponding to users participating in the virtual space, and others.

The data distribution unit 133 distributes content data to the user terminal, from which the access originated, at predetermined time intervals. The content data is for displaying images in the virtual space of the content selected with each terminal and managed by the content management unit 132.

The user management unit 134 stores and updates user information relating to users in the storage unit 120. The user information relating to a user includes an ID for identifying the user, the user name, and others.

The NG management unit 135 stores and updates NG information relating to NG words in the storage unit 120. NG words are words (messages) that have been designated so that their reflection in chats within virtual spaces can be restricted or controlled. The NG information regarding NG words includes, for example, information for specifying NG words set for each user and default NG words that are defined in advance.

The comment control unit 136 receives a comment posted by each user and transmits comment information for identifying the comment to a user terminal of a user participating in the same content as the user who posted the comment, thereby reflecting the comment in the virtual space of the content. Further, the comment control unit 136 determines whether a posted comment contains a NG word, and if the comment contains a NG word whose the reflection should be restricted, the comment control unit 136 restricts the transmission of the comment information so that at least the NG word contained in the comment is not reflected in the virtual space. In this embodiment, a posted message (comment) is shown as an example of an action in the virtual space and an action to be restricted. The action is not limited to a posted message (comment) as described later.

The mute management unit 137 stores and updates mute related information relating to muting in the storage unit 120. Muting is a function that prevents a comment posted by a specific user among other users, the specific user being designated by a user, from being reflected on the user terminal of that user. In this embodiment, if a user meets a predetermined restriction condition based on their mute-received history, indicating the user's received mute designation, a control is performed so that the reflection of their posted comments is restricted or limited not only on the user terminal of the user who has made a mute designation for the user but also on the user terminals of other users who have not made a mute designation (hereinafter this control is referred to as full mute control). For instance, the mute related information may include information for each user, such as a mute-received history in which the user has been mute-designated, a mute designation history in which the user has made a mute-designation of another user; information for specifying the history on full mute control; and information for specifying content that satisfies restriction conditions.

Based on the mute related information, the comment control unit 136 restricts the transmission of comment information to the user terminal of the user (hereinafter referred to as a “designation user”) who has designated the user who posted the comment as a mute target, so that the comment is not reflected on the user terminal of the designation user. If the user who posted the comment meets the restriction condition in accordance with their mute-received history and thus is a target of the full mute control, then the comment control unit 136 restricts the transmission of comment information so that the comment is not reflected not only on the user terminal of the designation user who has designated the user as a mute target but also on the user terminal of another user who has not made such a designation. In this embodiment, a posted message (comment) is shown as an example of an action in the virtual space and an action that is a target of muting and of full mute control. The action is not limited to a posted message (comment) as described later.

### <Configuration of Administrator Terminal>

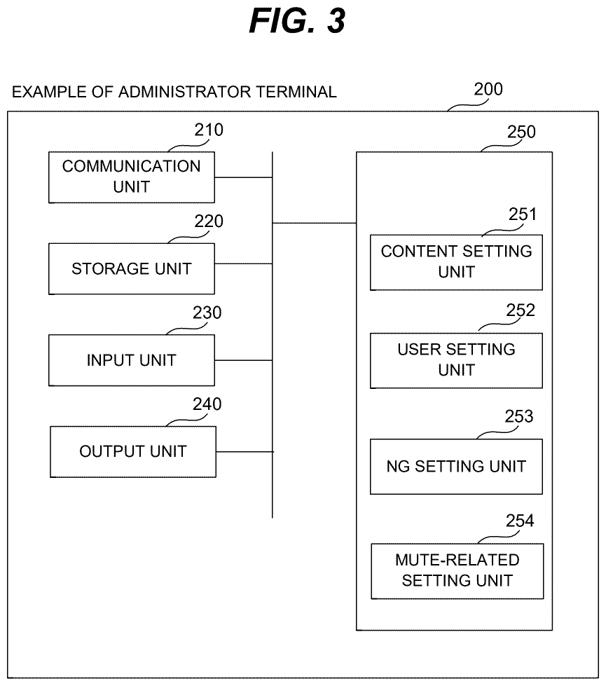

Next the following describes the configuration of the administrator terminal 200. As shown in FIG. 3, the administrator terminal 200 includes a communication unit 210 that communicates with other computers, a storage unit 220 that stores various data, an input unit 230 for inputting operations, an output unit 240 for outputting images and audio, and a controller 250 that controls the entire computer. These communication unit 210, storage unit 220, input unit 230, output unit 240, and controller 250 are connected to each other by a bus line.

The communication unit 210 is a communication interface including a NIC for performing wired or wireless communication. The communication unit 210 mainly communicates with the distribution server 100 via the network 2. The storage unit 220 includes a RAM and a ROM. The storage unit 220 stores programs for executing various control processes (e.g., programs for managing content using a virtual space), various data, and others.

The input unit 230 includes an input device (e.g., a pointing device such as a touch panel, a touch pad, or a mouse, and a keyboard)) for receiving input operations from the administrator. The output unit 240 includes an output device (e.g., display, speaker) for presenting information to the administrator.

The controller 250 includes a CPU. The controller 250 executes programs stored in the storage unit 220 to control the overall operation of the administrator terminal 200.

The following describes a functional configuration of the controller 250. The controller 250 functions as at least a content setting unit 251, a user setting unit 252, a NG setting unit 253, and a mute-related setting unit 254.

The content setting unit 251 stores and updates information about the content and virtual space that is managed by the content management unit 132 of the distribution server 100 in response to operations with the administrator terminal 200. This allows information for specifying content, information for specifying an image within the virtual space for each piece of content, information for specifying the date and time of the distribution, and information for setting and specifying a user (related SP user described later) who has the relevance with the content to be stored and updated in the storage unit 120.

The user setting unit 252 sets user information about a user that is managed by the user management unit 134 of the distribution server 100 in response to an operation with the administrator terminal 200. The user information settings include a distribution user setting that sets the user as a distribution user who is able to distribute content in response to a request from the user, and a SP user setting that sets the user as a special user (hereinafter also referred to as a SP user) who is able to set a NG word in response to a request from the user. For instance, when an application is received from a user who belongs to a performer or a celebrity and when the user satisfies certain standards (requirements), the operator sets the user as a distribution user or SP user. SP users are set up from among performers and celebrities. The operator may set a particular user as a distribution user or SP user even if no application is made.

In addition to the settings for SP user, the SP user settings include a type that is classified based on various parameters such as the user's genre, group, age group, and gender (e.g., a type of idol group A, a type of young actors, a type of big-name comedians, a type of professional baseball player, and a type of professional shogi players, hereinafter they may be called SP1, SP2, SP3 . . . ). A user who is set as a distribution user is able to initiatively distribute content, and is also necessarily set as a SP user who is able to set NG words. Therefore, in the distribution user settings, the type is also set when setting the distribution user as in the SP user. In the following, the SP user includes a distribution user. User information related to a user is set, whereby information for identifying the type of user (e.g., general user, distribution user, and SP user) is stored and updated in the storage unit 120 so as to correspond to a user ID for identifying the user. That is an example in which the distribution user settings and the SP user settings (including the type settings) are made in response to the operation with the administrator terminal 200 by the operator. The present invention is not limited to this, and instead of or in addition to this, the settings may be made in response to an operation with the user terminal by the user themselves. In this case, the operator may send, via the administrator terminal 200, to a user who belongs to performers and celebrities and is to be the target of distribution user settings or SP user settings, a setting form screen for distribution user settings or SP user settings or a URL that can be connected to the screen, so that the setting can be made according to the operation by the user who is the target of settings. This avoids the possibility of distribution user settings and SP user settings being made by general users.

The NG setting unit 253 sets NG information about a NG word that is managed by the NG management unit 135 of the distribution server 100 in response to an operation with the administrator terminal 200. The settings of NG information about NG words include: individual NG settings such as setting of NG word candidates requested in response to application from a SP user (including a distribution user) as the NG words of the user who made the request, or removing words requested by a user to be removed from the NG word list; and default NG settings such as setting/removing of default NGs for each type of SP user or default NGs common to all users.

For instance, when the candidate NG word requested from a SP user meets certain criteria (requirements) such as low risk of leading to excessive restrictions, the operator sets this candidate NG word as the NG word for the user. Note that a candidate NG word requested from a SP user may be set as a NG word of the SP user without waiting for the setting from the operator. For instance, a NG word candidate may be proposed from a SP user who is participating in the virtual space of certain content (including the case where the user themselves is distributing the content). In this case, the candidate may be set as a NG word for such a SP user without waiting for the setting from the operator. Then, in this case, the candidate may be set as a NG word only in the content in which the user is participating, and after the distribution of such content is completed, it may be removed from the NG word list and set as a NG word candidate, waiting to be set by the operator. This allows the candidate to be instantly set as a NG word in response to a request from the SP user only in the content in which the SP user is participating, and subsequently restricts the word from being reflected in the content in which the SP user is participating.

In addition, the operator sets words that are determined to be restricted based on, for example, the trends and fashions of the time, as default NG words. NG information related to NG words is set, whereby information for specifying a NG word so as to correspond to a user ID for identifying a user, and information for specifying NG words that are determined in advance for all users or NG words that are determined in advance for each type of SP users are stored and updated in the storage unit 120.

The mute-related setting unit 254 sets, in response to an operation on the administrator terminal 200, the cancellation of full mute control, the forcible activation of full mute control, a special user who is exempt from full mute control regardless of their mute-received history, the content of the restriction conditions, and others. In response to an operation to the administrator terminal 200, for example, the operator checks the current mute received history and the comment history in the most recent predetermined period of time in response to a request to cancel the full mute control from the target user, and if it is determined that there is a tendency for improvement, the operator cancels the full mute control, or if it is determined that a user should immediately be a target of full mute control on the basis of the user's mute received history or comment history in the most recent predetermined period of time, the operator forcibly activates full mute control for that user. Furthermore, in response to an operation to the administrator terminal 200, the operator sets a special user (e.g., a SP user) to be exempted from full mute control, regardless of their mute received history (hereinafter referred to as a “full mute excluded user”), for example, or changes or updates the restriction condition. In response to a request from the operator, the administrator terminal 200 may request mute related information, including mute received history of a designated user, and their past comment history from the distribution server 100, and display the mute related information, including the mute received history of the designated user, and comment history in the most recent predetermined period of time, on the basis of the information in response to the request. Furthermore, the administrator terminal 200 may transmit information capable of specifying the settings to the distribution server 100 in response to a setting operation performed by the operator, and may update the information to be stored in the storage unit 120 in accordance with the settings. The full mute excluded user and restriction condition set by the operator are stored in the storage unit 120 of the distribution server 100. Note that the operator may set a full mute excluded user in accordance with a request from a SP user, for example, to exclude the user from full mute control.

### <Configuration of User Terminal>

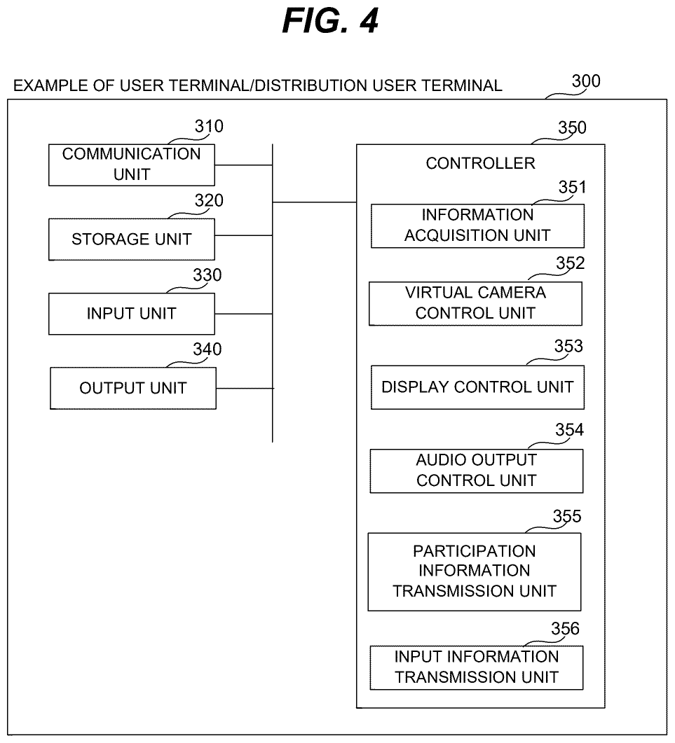

Next, the following describes the configuration of a user terminal (user terminal 300 and distribution user terminal 400) in detail. As shown in FIG. 4, a user terminal includes a communication unit 310 that communicates with other computers including the distribution server 100, a storage unit 320 that stores various data, an input unit 330 for inputting operations, an output unit 340 for outputting images and others, and a controller 350 that controls the entire computer. These communication unit 310, storage unit 320, input unit 330, output unit 340, and controller 350 are connected to each other by a bus line.

The communication unit 310 is a communication interface including a NIC for performing wired or wireless communication. The communication unit 310 communicates with other computers including the distribution server 100 via the network 2. The storage unit 320 includes a RAM and a ROM. The storage unit 320 stores programs for executing various control processes (e.g., programs for viewing content using a virtual space, and programs for distributing content using a virtual space in a distribution user terminal via the distribution server 100), various data, and others.

The input unit 330 includes an input device (e.g., a pointing device such as a touch panel, a touch pad, or a mouse, a keyboard, and a microphone) for receiving input operations and sounds from a user. The distribution user terminal 400 includes an input device such as an HMD with a motion capture function and includes a motion input unit that is an input unit 330 to acquire user motions as motion information. In this way, the distribution user terminal 400 used by a distribution user for content distribution has hardware and functions different from those of the user terminal 300 used for participation as a general user.

The output unit 340 includes an output device (e.g., display, or speaker) for presenting and outputting information (text, images, sounds and others) to a user. The controller 350 includes a CPU. The controller 350 executes programs stored in the storage unit 320 to control the overall operation of the user terminal 300.

The following describes a functional configuration of the controller 350. The controller 350 functions as an information acquisition unit 351, a virtual camera control unit 352, a display control unit 353, an audio output control unit 354, a participation information transmission unit 355, and an input information transmission unit 356.

The information acquisition unit 351 acquires content data, comment information, and others from the distribution server 100 via the communication unit 310, and stores in the storage unit 320 information for displaying an image in a virtual space in which various objects are placed based on the content data, and also stores in the storage unit 320 information for displaying comments posted based on the comment information.

The virtual camera control unit 352 controls a virtual camera that is placed in the virtual space stored in the storage unit 320 and specifies a region (visible region) of an image in the virtual space to be displayed on the user terminal 300. The virtual camera control unit 352 controls the position, orientation, inclination, and others of the virtual camera in response to an operation with the input unit 330.

The display control unit 353 displays on a display unit (such as a display) an image corresponding to the visible region, which is the field of view from the virtual camera, in the virtual space stored in the storage unit 320, on the basis of the content data acquired by the information acquisition unit 351. In other words, the user can change the position, orientation, inclination and others of the virtual camera placed in the virtual space in response to operations with the input unit 330, so that the user terminal 300 displays an image within the visible region of the virtual camera among the image in the virtual space for viewing.

This embodiment describes an example where information for displaying an image in a virtual space based on content data is stored in the storage unit 320, a virtual camera is placed in the virtual space stored in this storage unit 320, and the visible region displayed on the user terminal 300 is changed by controlling the virtual camera. The present invention is not limited to this. For instance, the user's virtual camera may be placed in the virtual space stored in the storage unit 120 of the distribution server 100, and the virtual camera control unit 352 may be used to control the virtual camera to change the visible region of the virtual camera. Then data to specify an image in the visible region may be received and displayed on the user terminal 300.

The display control unit 353 causes the display unit (e.g., a display) to display the history of posted comments stored in the storage unit 320 based on the comment information acquired by the information acquisition unit 351. The audio output control unit 354 causes an audio output unit (e.g., speaker) to output sounds on the basis of the content data acquired by the information acquisition unit 351.

The display control unit 353 displays user interface (UI) images (including a menu image selectable by the user and an operation image that accept operations) corresponding to the content being distributed on the basis of the program stored in the storage unit 320. In this embodiment, different UI images are displayed on a user terminal 300, which is used for participation as a general user, and on a distribution user terminal 400, which is used by a distribution user for content distribution. For instance, a UI image for posting a comment may be displayed on the user terminal 300 (when the program is executed for viewing/experience), but not displayed on the distribution user terminal 400 (when the program is executed for content distribution), which mainly communicates by sounds. The menu items required are different also between during viewing/experiencing and during content distribution. Thus, the UI image for selecting a menu may differ between the user terminal 300 (when executing a program for viewing/experiencing) and the distribution user terminal 400 (when executing a program for content distribution).

The participation information transmission unit 355 transmits participation information to the distribution server 100 when a user indicates a desire to participate on a screen showing a list of information on the content being distributed. The participation information indicates that the user will participate in the content that the user has input (selected) via the input unit 330. The participation information includes information for specifying the content to be participated in and the user ID of the user.

The input information transmission unit 356 transmits the audio information, operation input information, and others acquired by the input unit 330 to the distribution server 100. The operation input information includes various types of information, such as operation information for specifying operations on objects in the displayed virtual space and on the user characters placed in the virtual space (including motion information acquired by the motion input unit 260 (such as an HMD)), comment posting information for specifying a comment input by a user when the user posts a comment in the participating content, user application information for specifying setting and cancelling applications by distribution users and SP users, and setting and cancelling applications for NG words, mute designation information for specifying a user designated as a mute target and a designation user who designates the user as a mute target, mute cancellation information for specifying the user who is to be cancelled from the mute target among the users who have been designated as the mute target and the cancelling user who is to cancel the designation of the mute target, full mute cancellation request information to apply for cancellation of full mute control, and full mute selection information that allows a user to select whether to reflect a comment from the user who is a target of the full mute control without restricting it or to restrict the reflection.

To apply for a NG word setting, instead of or in addition to inputting a message about a candidate NG word, the SP user themselves may drag and highlight a part of the message to be used as a candidate NG word from the comment reflected in the comment history in the virtual space of the content in which they are participating. This reduces the time and effort required to apply for NG word candidates.

In this embodiment, regardless of whether or not a comment input by a user to post the comment contains a NG word, the comment is reflected in the virtual space of the content displayed on the user terminal of the user at the time of input (posting). If the reflection of a posted comment is restricted because it contains a NG word, the reflection will be restricted in the virtual space of content that is displayed on the user terminals of users other than the user who posted the comment.

### <Types of Content>

Next, the following describes an example of the types of content provided by the distribution server 100. For instance, the types of content provided can be broadly divided into: content for communication with other participating users that is not related to any of the SP users (including distribution users) who are set as performers and celebrities; and content that is related to any of the SP users. For instance, examples of the content that is not related to any of the SP users include content that is not distributed initiatively by any of the SP users, in which the participation of any of the SP users has been decided in advance, and content that is not based on the intention of communication with any of the SP users (e.g., a gathering of fans of a particular performer who is a SP user). In contrast, examples of the content that is related to any of the SP users include content that is distributed initiatively by any of the SP users, content in which the participation of a SP user at any timing has been decided in advance before the start of the content, and content that is based on the intention of communication focusing on any of the SP users (e.g., content where fans of a particular performer who is a SP user will be gathered).

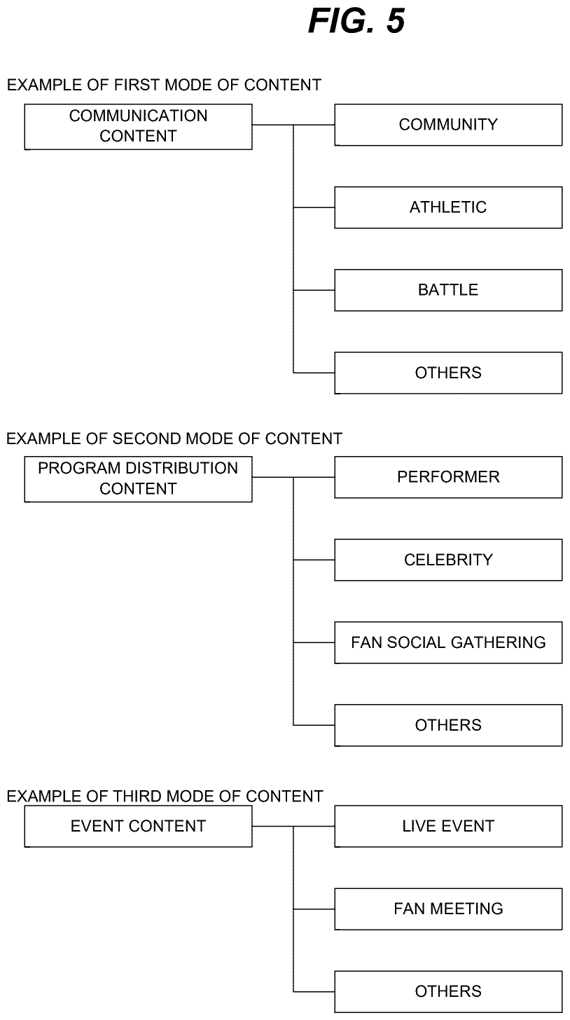

As shown in FIG. 5, communication content is provided, which is not related to any SP user and is for communicating with other participating users. For example, this includes community content for exchanging information about a particular region, athletic content in which a user controls a user character to play an athletic game together with other users, and battle content in which a user controls a user character to battle with other users. Hereinafter, the content that is not related to any SP user and that is for communication with other participating users is also called a first mode of content.

For the first mode of content, a user is able to participate in the desired content at any time, and a SP user, such as a performer or celebrity, also is able to participate in the desired content at any time. Thus, the first mode of content can be content in which a SP user may or may not participate, and in which topics may or may not be about any of the SP users, and it can be content that is not related to SP users.

In contrast, content that is related to any of the SP users includes program distribution content that is distributed on a regular basis and event content that is distributed as a live event. Program distribution content includes: talent content in which a specific talent set as a SP user appears and distributes content initiatively; celebrity content in which a specific celebrity set as a SP user appears and distributes content initiatively; and fan social gathering content in which a specific performer or celebrity set as a SP user do not appear but their fans gather and communicate with each other. Hereinafter, of the content that is related to any SP user, the program distribution content that is distributed on a regular basis is also called as a second mode of content.

Event content includes: live content in which a live event by a specific talent (e.g., a specific singer, a specific idle group) set as a SP user is distributed, and a fan meeting (this may be called a fan service) content in which a specific performer and others communicate with their fans.

Event content is expected to attract a relatively larger number of users than in program distribution content. This means that comments for the event content will be posted more frequently by many users, and the period during which each comment is displayed will become shorter, making them harder to understand. In addition, in the case of live event content, it will become more likely that the SP user will not be able to recognize the comments and will have difficulty reacting to them. For this reason, when distributing live event content, multiple rooms (corresponding to multiple virtual spaces) are prepared for the content, and participating users are assigned to one of the multiple rooms to enter, so that only comments from users in the room they are in are displayed on the user terminal of the participating users, and comments from users entering other rooms are not displayed.

A SP user who distributes the live event is able to select the room that they will enter from the multiple rooms, and view an image of the selected room (within the virtual space) displayed on the SP user's user terminal, while checking comments from the users in the room. This allows comments posted by many users participating in the live event content to be distributed over the multiple rooms, thus preventing the period during which each comment is displayed from becoming too short and making it easier for the SP user who is the main character in the live event to recognize the comments and preventing the SP user from having difficulty in reacting to the comments. Meanwhile, depending on the type of content, the motion and sound of a user character of a specific performer related to the live event content may be reflected only in the room selected by the specific performer (i.e., only users who enter the room selected by the specific performer is able to view them), or may be mirrored in the multiple rooms corresponding to the content (i.e., all users who enter the multiple rooms are able to view the content regardless of the room selected by the specific performer). Hereinafter, of the content that is related to any SP user, content that is distributed as in a live event is also called as a third mode of content.

For both the second and third modes of content, users who wish to participate becomes able to participate (enter) or the user character of the SP user who becomes the main character is displayed at a predetermined date and time, and then the event will start. For the second third modes of content, the user character of the SP user is displayed in the virtual space at the timing determined by the operator or the timing for the SP user who distributes the content initiatively, with the exception of the content of fan social gathering. Of the second mode of content, fan social gathering content is for fans of a specific SP user to gather, and the specific SP user does not participate. This means that the second and third modes of content can be the content in which a specific SP user always participates or the topics about a specific SP user always come up, and thus can be the content related to any SP user. However, even during a period in which general users are participating in the content, there may be a period during which the user character of the SP user who becomes the main character or the subject of the content does not substantially appear (is not displayed) in the virtual space.

As described above, the first through third modes of content are managed in the content management unit 132 of the distribution server 100 in response to operations with the administrator terminal 200. A user terminal is capable of participating in the content by accessing the distribution server 100 and selecting any of multiple types of content on the screen for selecting the content that the user wishes to view from among the multiple types of content. The distribution server 100 causes the log management unit 131 to store and update log information for each type of content in the storage unit 120.

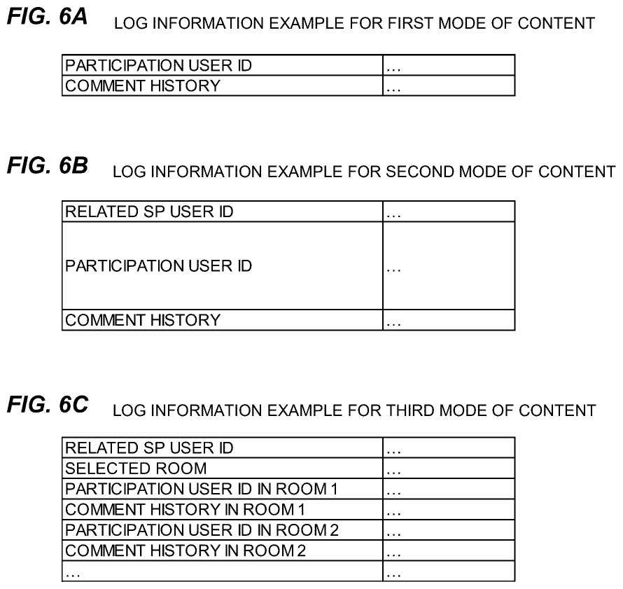

FIG. 6A to FIG. 6C describe one example of the log information stored in the storage unit 120 of the distribution server 100. FIG. 6A shows items of log information that are stored when a user participates in any of the first modes of content. For the first mode of content, the user IDs of the participating users who are participating in the content, and a comment history for specifying comments posted to the content and the users who posted the comments are stored for each piece of content. As shown in FIG. 6A, participating users (users participating in a content group) who participate in common content among the first modes of content and are associated with that content (group) can be users who have a specific relationship.

FIG. 6B shows items of log information that are stored when a user participates in any of the second modes of content. For the second mode of content, the user ID of a specific SP user being related to the content (e.g., a distribution user who initiatively distributes the content, or a performer who has gathered fans; hereinafter, also referred to as a related SP user), the user IDs of participating users who are participating in the content, and a comment history for specifying comments posted to the content and the user who posted the comments are stored for each piece of content. As shown in FIG. 6B, the related SP user and participating users who participate in common content among the second modes of content and are associated with that content (group) can be users who have a specific relationship.

FIG. 6C shows items of log information that are stored when a user participates in any of the third modes of content. For the third mode of content, a related SP user who is related to the content is defined for each piece of content. For the third mode of content, a plurality of virtual spaces are associated with one piece of content. For the third mode of content, a plurality of rooms each corresponding to one of a plurality of virtual spaces is provided, and a user participating in the content is assigned to one of the rooms. The related SP user (e.g., distribution user who distributes a lie event, and a performer who has gathered fans) who are related to the content is able to select a room to enter and check the images and comments in that room. Thus, for the third mode of content, the user ID of the related SP user who is related to the content, the selected room selected by the related SP user from among the multiple rooms, the user ID of a participating user assigned to room 1 of the multiple rooms and the comment history posted to room 1, and the user ID of a participating user assigned to room 2 of the multiple rooms and the comment history posted to room 2 are stored for each piece of content. In this way, the user IDs of participating users and the comment history are stored for each of the rooms. As shown in FIG. 6C, the related SP user and participating users who participate in common content among the third modes of content and are associated with that content (e.g., group, multiple rooms) can be users who have a specific relationship.

During the distribution of a first mode of content, a special condition for a SP user is not met because the special condition is met during the period when the SP user is initiatively distributing the content or the period when the SP user is gathering fans. In contrast, during the distribution of a second mode of content and a third mode of content, such a special condition for the SP user is met.

Participating in any of the content, a user is able to view images and others in a virtual space corresponding to the content, while posting and checking comments, which are one type of action. Note that, if any NG word, which should be restricted, is included, this embodiment restricts the NG word so that it is not reflected in the virtual space of the content. As described above, the SP user is able to apply for a NG word candidate by operating the user terminal. Then, the operator is able to check what the user has applied for by connecting to the distribution server 100 via the administrator terminal 200, and is able to set and update the NG information regarding NG words managed by the NG management unit 135 of the distribution server 100 using the NG setting unit 253 in response to operations with the administrator terminal 200.

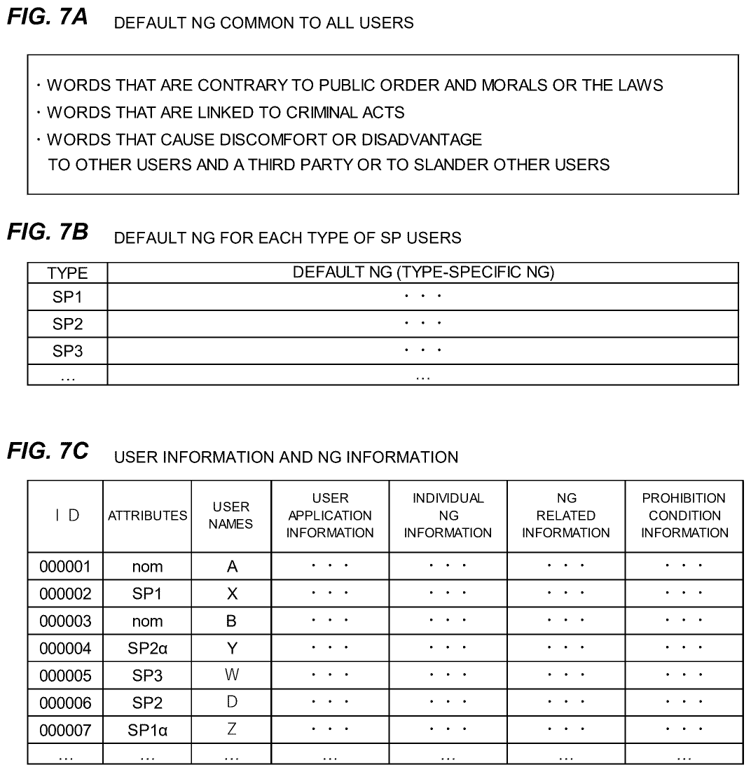

FIG. 7A to FIG. 7C show one example of the NG information stored in the storage unit 120 of the distribution server 100. The NG information stored in the storage unit 120 includes information for specifying default NG words commonly applied to all users. As shown in FIG. 7A, default NG words that are applied to all users are set by the operator, and include words that are contrary to public order and morals or the law, words that are linked to criminal acts, and words that have the potential to cause discomfort or disadvantage to other users or to slander other users.

The NG information stored in the storage unit 120 also includes information for specifying default NG words applied to each type of SP users. The words that SP users wish to set as NG words tend to vary depending on the SP user's genre, group, age range, and others. But if they are of the same type, the same words tend to be included and application for the same words tend to be made by SP users of the same type. For this reason, the operator takes into account the type of a SP user and sets the default NG words to be applied for each type in advance. This reduces the time and effort required for each SP user to set up their own NG words from the very beginning. Note that the default NG words set for each type differ depending on the type, and therefore different NG words can be used for each type. As shown in FIG. 7B, NG information to specify default NG words are stored for each type of SP users

The NG information stored in the storage unit 120 also includes NG information stored for each user. FIG. 7C shows the NG information stored for each user. The NG information for each user is stored corresponding to user information including, for example, the user ID and user name. The user name and the type of the user (e.g., general user: nom, SP user: SP1, SP2, . . . , distribution user: SP1a, SP2a, . . . ) are stored corresponding to a user ID, and user application information, individual NG information, NG-related information, and prohibition condition information are stored as the NG information.

The application information is for specifying what the user has applied for. The application information includes information indicating a user's desire to set up or cancel the distribution user settings and SP user settings, and information for specifying NG word candidates applied for registration from a SP user, and NG words applied for cancellation from a SP user. The operator connects to the distribution server 100 via the administrator terminal 200, checks and considers what the user has applied for based on the application information, sets or cancels the distribution users and others, and sets or cancels NG words for each user. When setting or cancellation is made for a distribution user, for example, the type shown in FIG. 7C is updated. When setting or cancellation is made for a NG word for each user, the individual NG information shown in FIG. 7C is updated.

The individual NG information shown in FIG. 7C is for specifying NG words set for each user. For instance, when a user's NG word is set by the operator, information to specify the NG word is additionally stored in the individual NG information for that user, and when a user's NG word is canceled by the operator, information to specify the NG word is deleted from the individual NG information for that user. Note that the NG words set individually differ depending on SP users, and therefore different NG words can be used for each SP user.

The NG-related information shown in FIG. 7C is for specifying the history of NG word when the reflection of a comment was restricted because the comment posted by a user contains a NG word. When the comment controller 136 of the distribution server 100 restricts the reflection of a comment in the virtual space because the comment contains a NG word, the comment controller 136 stores and updates NG-related information for the user who posted the comment, the NG-related information including information that is capable of specifying the NG word (message) contained in the comment and the SP user (the SP user, for whom the restriction is required) who sets the word as the NG word to be restricted (including the case of setting it as a type-specific NG). The NG-related information is updated each time a user posts a NG word and it is restricted.

This embodiment is configured so as to, for a user who satisfies a prohibition condition based on the NG-related information for the user, control to prohibit the user from posting comments thereafter, regardless of whether the comments contain a NG word. For instance, when the number of times that a user posted NG words to a certain SP user reaches a predetermined number (e.g., five times), it is determined that the user satisfies the prohibition condition, and the user is prohibited from posting comments on the content that is related to the SP user.

Furthermore, a user who repeatedly uses a NG word also tends to repeatedly use the NG word also against other SP users of the same type as the SP user who sets the NG word. Thus, the posting of comments from a user who satisfies the prohibition condition based on NG-related information for one SP user is prohibited not only for content to which this SP user is related, but also for content to which the same type of SP user as this SP user is related.

The prohibition condition information shown in FIG. 7C is information for specifying the type of SP user who becomes a target to satisfy the prohibition condition and information for identifying the SP user. When a comment is posted from a user who satisfies the prohibition condition in the content to which a SP user of the type as a prohibition target is related, the comment control unit 136 of the distribution server 100 prohibits the comment from being reflected in the virtual space, regardless of whether the comment contains a NG word.

### Specific Example of Comment Control in First Mode of Content

Next, the following describes a specific example of the comment control during distribution of a first mode of content. For the first mode of content, a user who is not related to any of SP users is able to participate in at any time, regardless of whether they are a SP user, a performer or a celebrity. This means that a SP user who has set a NG word participates in as a general user and not as a distributor in the middle of content in which general users are already participating and interacting with each other. It is not possible to predict whether this SP user will participate in the content or at what timing the SP user will participate. In addition, a comment containing the NG word set by the SP user who is trying to participate has already been posted in the virtual space of the content. For this reason, the present embodiment is configured so as to, during distribution of a first mode of content, determine whether or not the users participating in the same content include a SP user, and perform comment control according to the determination result. Furthermore, when a SP user participates in any of the first modes of content, the present embodiment controls to delete a comment including a NG word set by the SP user from the comment history for updating, and reflect the comments in the virtual space.

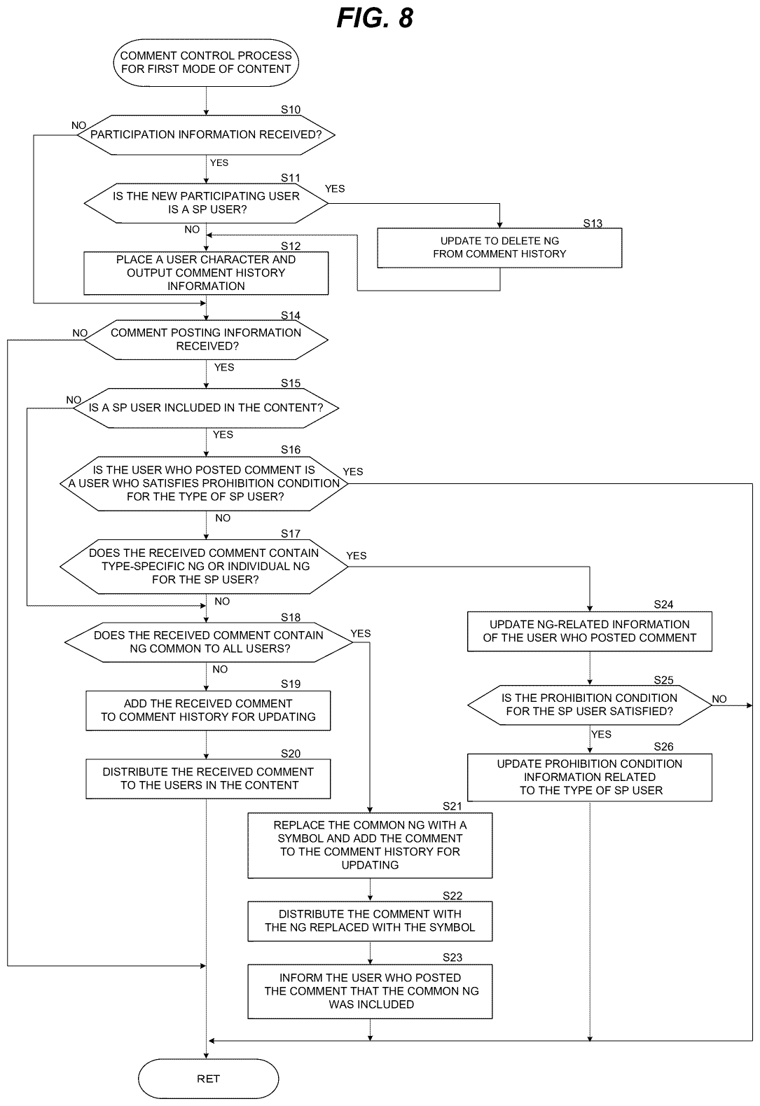

FIG. 8 is a flowchart of the comment control process during distribution of a first mode of content. The comment control process during distribution of a first mode of content is executed for each piece of content, and is repeatedly executed by the controller 130 of the distribution server 100 at predetermined time intervals. The distribution server 100 performs various processes including the comment control process during distribution of a first mode of content on the basis of the program stored in the storage unit 120.

First, in step S10, the process makes a determination as to whether participation information has been received from a user terminal. If it is not determined that the participation information has not been received, the process proceeds to step S14. If it is determined that the participation information has been received, the process makes a determination in step S11 as to whether the new participating user is a SP user who is able to set a NG word. In step S11, based on the user information shown in FIG. 7C, the determination is made whether the type of user ID specified from the received participation information is SP rather than nom.

If it is not determined in step S11 that the newly participating user is a SP user, the process proceeds to step S12 to place a user character corresponding to the newly participating user at a predetermined position in the virtual space of the content, and output comment history information for specifying the comment history of the content (see FIG. 6A) to the user terminal of the newly participating user. This allows the content data in which the user character of the newly participating user is placed in the virtual space to be distributed from the distribution server 100, and allows the user character to be reflected and displayed in the virtual space on the user terminal of the user who is participating in the content. Furthermore, the user terminal of the newly participating user receives the comment history information and thereby specifies and displays the comment history posted in the content in which the user has participated.

If it is determined in step S11 that the user is a SP user, the process proceeds to step S13. In this step, if the comment history of the content in which the user participated contains a NG word (e.g., individual NG, type-specific NG) set for the newly participating SP user, the process deletes the comment containing the NG word from the comment history for updating, and proceeds to step S12. Even if the comment history includes a comment including the NG word set for the SP user at the timing when the SP user joins, this allows the comment history information with the comment including the NG word deleted to be output. This therefore prevents a comment containing the NG word from being displayed on the user terminal of the SP user.

If the comment including the NG word set for the newly participating SP user is deleted from the comment history for updating in step S13, the comment history information is output only to the SP user. The present invention is not limited to this. This comment history information may also be output to the user terminals of other users participating in the content in addition to the SP user, so that the comment including the SP user's NG word is not displayed in the comment history on the user terminals of these users. That is a description on the example in which, in step S13, the comment including the NG word set for the newly participating SP user is deleted from the comment history for updating. However, the present invention is not limited to this. The comment including the NG word set for the newly participating SP user may be updated so that the part of the NG word is replaced with a symbol (e.g., asterisk) as described below.

In step S14, the process makes a determination as to whether a comment has been posted to the content from any of the participating users, that is, whether comment posting information has been received. If it is not determined that comment posting information has been received, the comment control process ends. If it is determined that comment posting information has been received, the process makes a determination in step S15 as to whether a SP user is included in the content. Specifically, it is determined whether a SP user ID is included in the participating user IDs shown in FIG. 6A.

If it is not determined in step S15 that the SP user is included, then the process makes a determination in step S18 as to whether the comment (received comment) specified from the comment posting information includes a default NG common to all users shown in FIG. 7A. If it is not determined in step S18 that a default NG common to all users is included, the process adds the received comment to the comment history of the content for updating in step S19. In step S20, the process distributes comment information to specify the received comment to the user terminals of participating users (excluding the user terminal of the user who posted the comment). This allows the posted comment to be reflected in the virtual space. As described above, on the user terminal of the user who posted the comment, the comment is reflected in the virtual space displayed on the user terminal of the user at the time when the comment was input.

If it is determined in step S18 that the default NG common to all users is included, the process proceeds to step S21 to replace the part of the message in the comment corresponding to the default NG with a symbol (e.g., one letter is replaced with asterisk) and add this comment to the comment history of the content for updating. In step S22, the process distributes comment information to specify the received comment with the part of default NG replaced with the symbol to the user terminals of participating users (excluding the user terminal of the user who posted the comment). This allows the posted comment with the part of default NG replaced with the symbol to be reflected in the virtual space. In the first mode of content, a user who becomes the main character/subject of content is not specified. Thus, it is likely to be a conversation (exchange of messages) among the participating users. Then, the default NG part is replaced with a symbol to make the remaining part readable. If the entire comment, including the default NG, is not reflected, a problem may occur, such as a failure to carry on a conversation, thus causing an awkward feeling. This step prevents such a problem. As described above, on the user terminal of the user who posted the comment, the comment including the default NG is reflected in the virtual space displayed on the user terminal of the user at the time when the comment was input.

In step S23, the process transmits notification information to the user terminal of the user who posted the comment to inform that the default NG common to all users was included. This causes a message to be displayed on the user terminal of the user who posted the comment, such as “The comment was partially reflected because it contained a default NG common to all users.” As a result, the user who posted the comment is allowed to know that the comment they posted contained the default NG common to all users.

If it is determined in step S15 that the content includes a SP user, the process makes a determination in step S16 as to whether, based on the NG-related information in FIG. 7C, the user who posted the comment is a user who satisfies the prohibition condition for the type of the SP user (the SP user participating in the same content). If it is determined in step S16 that the user who posted the comment is a user who satisfies the prohibition condition for the type of the SP user, the comment control process ends. This prohibits comments from being posted from the user who satisfies the prohibition condition for the type of SP user participating in the same content.

If it is not determined in step S16 that the user who posted the comment is a user who satisfies the prohibition condition for the type of the SP user, then the process makes a determination in step S17 as to whether the received comment contains the default NG for the type of the SP user shown in FIG. 7B or contains the individual NG for the SP user shown in FIG. 7C.

If it is not determined in step S17 that either the default NG of the type of the SP user or the individual NG of the SP user is included in the received comment, the process proceeds to step S18. Note that if it is not determined in step S15 that a SP user is included, the steps including step S17 will not be executed, and even if the comment contains a NG word that is set for any SP user who is not participating, the comment containing the NG word will be reflected in the virtual space.

If it is determined in step S17 that either the default NG of the type of the SP user or the individual NG of the SP user is included in the received comment, the process updates the NG-related information of the user who posted comment in step S24. This makes it possible to specify the NG word included in the comment and the SP user who sets the word as the NG word to be restricted (including the case of setting the type-specific NG) as NG history from the NG-related information of the user who posted the comment.

Between step S16 and step S17, the process may make a determination as to whether the content contains more than one SP user. In this case, if it is not determined that the content includes a plurality of SP users, the process proceeds to step S17. If it is determined that a plurality of SP users is included, then the process makes a further determination as to whether the received comment contains a type-specific NG for each of these SP users, and if the type-specific NG is not included, the process proceeds to step S18. If the type-specific NG is included, the process may restrict the reflection and proceed to step S24. This prevents too few comments from being reflected when multiple SP users are included. The present invention is not limited to this. When the types of multiple SP users included in the content are different, it may be determined whether a common type-specific NG is included among the type-specific default NGs of these types, or it may be determined whether one of the type-specific NGs is included among the default NGs of these types.

In step S25, the process makes a determination as to whether the prohibition condition for the SP user is satisfied based on the NG-related information of the user who posted the comment. For instance, it is determined whether the number of times the NG word has been posted to the SP user has reached a predetermined number. If it is not determined in step S25 that the prohibition condition is satisfied, the comment control process ends. If it is determined in step S25 that the prohibition condition is satisfied, the prohibition condition information is updated in step S26 to specify the type of SP user who is a target of the prohibition condition being satisfied. This prevents this user (who posted the comment) from posting a comment within the virtual space of content that is related to a SP user of the same type as that is identified from the prohibition condition information, even if the user has not posted the NG word set by the SP user.

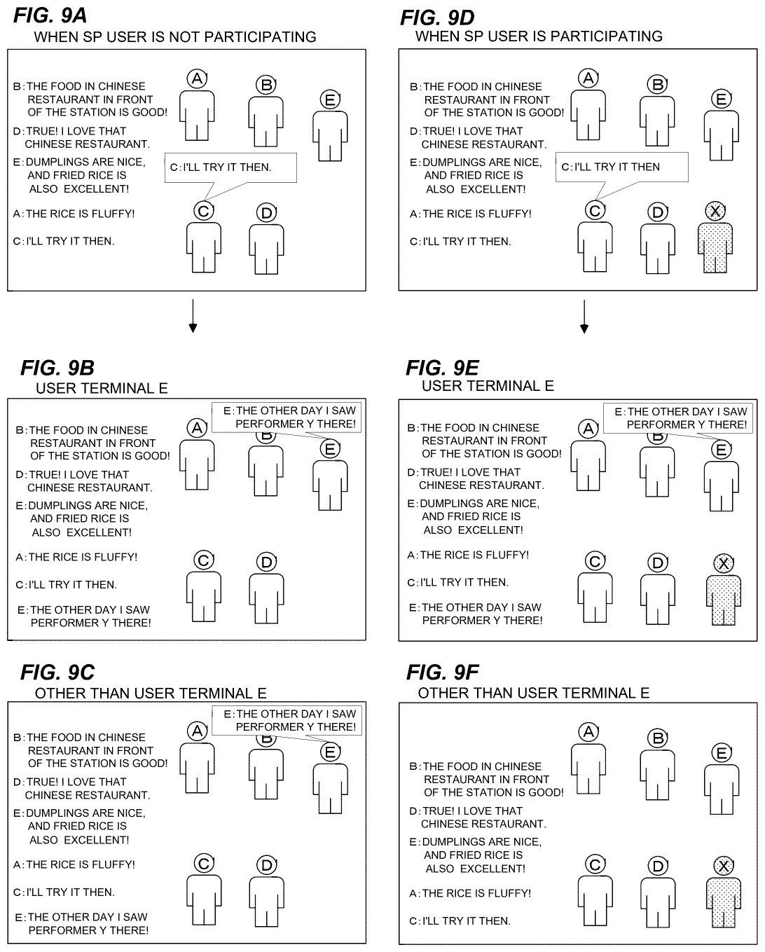

FIG. 9A through FIG. 9F illustrate display examples of a user terminal during distribution of a first mode of content. FIG. 9A through FIG. 9F show display examples of a user terminal of a user participating in community content of the first modes of content. FIG. 9A through FIG. 9C illustrate a situation where a SP user is not included among the users participating in the community content. As shown in FIG. 9A, which shows the user terminal of a user participating in the community content, a field is displayed, in which the user characters of the users participating in the community content move and emote freely from the center to the right area of the screen, and a history of a certain number of comments most recently posted to the community content is displayed in the left area of the screen. In addition to displaying a certain number of most recent comments, the comment history may also be capable of displaying comments posted prior to the certain number of comments by going back in time, in response to an operation.

FIG. 9A shows user characters A to E corresponding to users A to E displayed on the field, comments posted in the order of users B, D, E, and A from the comment history, and a comment such as “I'll try it then!” posted by user C. When a comment is posted, the content of the comment is displayed next to the user name in a word-bubble object from user character C in FIG. 9A, and the content of the comment is also displayed next to the user name in the comment history. This allows the users to be informed of the most recently posted comment in an easily understandable manner.

Following the comment posted from user C, FIG. 9B shows an example of the display on user terminal E of user E when user E posted a comment such as “The other day, I saw performer Y there!”, and FIG. 9C shows an example of the display on a user terminal of a user other than user E who posted the comment. On user terminal E of user E who posted the comment, the posted comment is reflected in the virtual space regardless of whether the comment contains a NG word when posted it, as described above. A user terminal of a user other than the user who posted the comment receives the comment information transmitted in step S20 or S22 of FIG. 8, and has the posted comment reflected in the virtual space.

FIG. 9B and FIG. 9C show a situation where no SP user is included among the participating users, and thus even if a comment is posted that includes a NG word set by one of the SP users, the posted comment is reflected in the virtual space. Therefore, as shown in FIG. 9B and FIG. 9C, the comment from user E is reflected in the virtual space not only on user terminal E but also at a user terminal other than user terminal E.

Note that as mentioned above, the first mode of content allows users, including performers and celebrities, to participate in the content they desire at any time. Therefore, even if no performer or others is participating at the start of distribution, they may join in midway through. FIG. 9D illustrates a situation where the comments posted are the same as in FIG. 9A, but a SP user is included among the users participating in the community content.

FIG. 9D shows, in addition to user characters A to E corresponding to users A to E displayed on the field, user character X corresponding to SP user X who is a SP user, comments posted in the order of users B, D, E, and A from the comment history, and a comment such as “I'll try it then!” posted by user C. As shown in FIG. 9D, the user character of SP user X is displayed, and the user name of SP user X is displayed when they post a comment, for example. This allows other users participating in the content to know that the SP user is participating, and thus increases the likelihood that they will post a comment about the SP user. The user name of a user character may be always displayed near the user character (e.g., above the head) in correspondence with the user character, and in addition, for SP users, a unique icon according to the type may be displayed at the beginning of the line of the user name displayed in correspondence with the user character. It is assumed that the message “I'll try it then!” from user C does not include any of the NG words set by SP user X or the NG words common to the type of SP user X. Thus, the comment from user C is reflected in the virtual space of the content.

Following the comment posted from user C shown in FIG. 9D, FIG. 9E shows an example of the display on user terminal E of user E when user E posted a comment such as “The other day, I saw performer Y there!”, and FIG. 9F shows an example of the display on a user terminal of a user (including SP user X) other than user E who posted the comment. It is assumed that SP user X is an entertainment performer and has set names of some performers as NG words because they do not want the names of other performers who have been rivals to be post, and that “performer Y” is among the NG words.

Also in this case, on user terminal E of user E who posted the comment, the posted comment is reflected in the virtual space regardless of whether the comment contains a NG word when posted it, as described above. This means that, as shown in FIG. 9E, even if the participating users include SP user X and a comment is posted that includes a NG word set by SP user X, the posted comment is directly reflected on user terminal E.

A user terminal of a user other than the user who posted the comment receives the comment information transmitted in step S20 or S22 of FIG. 8, and reflects the posted comment in the virtual space. Note here that the comment posted by user E includes a NG word set by SP user X, and thus the process determines YES in step S17 in FIG. 8, meaning that the comment information is not transmitted in step S20 or S22 in FIG. 8. Thus, in FIG. 9F, which shows a display example on a user terminal other than user terminal E, the comment from user E shown in FIG. 9C is not displayed or reflected in the virtual space of the content at all.

### Specific Example of Comment Control in Second and Third Modes of Content

Next, the following describes a specific example of the comment control during distribution of second and third modes of content. The second and third modes of content is related to a specific performer or celebrity, and the specific performer or celebrity will always participate or the topic about the specific performer or celebrity will always come up. However, even during the content distribution period (e.g., the period during which general users are participating in the content), there may be a period during which a related SP user, such as a user character of a particular performer who becomes the main character or subject of the content, does not actually appear (is not displayed) in the virtual space, and there may be a case where they may not appear from the start to finish, as in a fan social gathering. During such a period, a NG word set by the related SP user may be reflected in the virtual space. This may incite participating users to use further NG words, which is not a desirable situation for the related SP user. Thus, during the distribution of the second and third modes of content, this embodiment is configured to perform comment control to restrict the reflection of a NG word set for the relevant SP user who is relevant to the content, regardless of whether the relevant SP user is actually included in the participating users of the content.

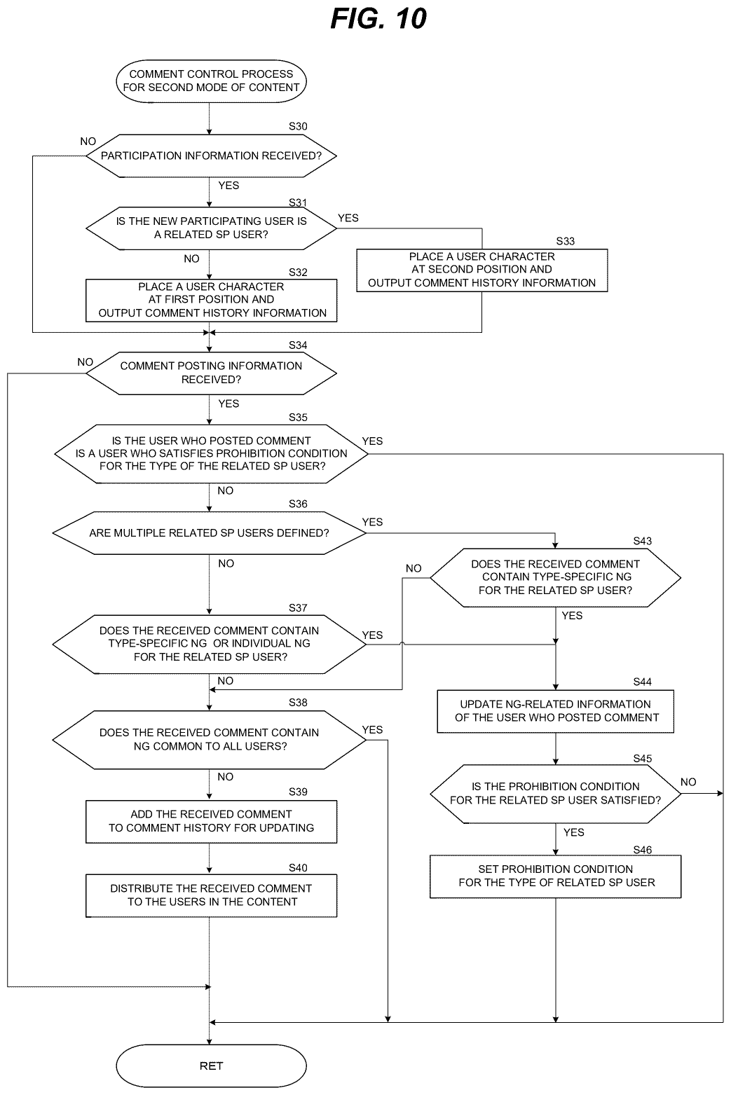

FIG. 10 is a flowchart of the comment control process during distribution of a second mode of content. The comment control process during distribution of a second mode of content is executed for each piece of content, and is repeatedly executed by the controller 130 of the distribution server 100 at predetermined time intervals. The distribution server 100 performs various processes including the comment control process during distribution of a second mode of content on the basis of the program stored in the storage unit 120.

First, in step S30, the process makes a determination as to whether participation information has been received from a user terminal. If it is not determined that the participation information is received, the process proceeds to step S34. If it is determined that the participation information has been received, the process makes a determination in step S31 as to whether the new participating user is a related SP user (e.g., distribution user, or SP user) who is a user who becomes the main character or the subject of the content being distributed and is relevant to the content. In step S31, it is determined whether the user ID is of the related SP user, which is stored for each piece of content shown in FIG. 6B.

If it is not determined in step S31 that the newly participating user is a related SP user, the process proceeds to step S32 to place a user character corresponding to the newly participating user at a first position (e.g., an audience seat) in the virtual space of the content, and output comment history information for specifying the comment history of the content (see FIG. 6B) to the user terminal of the newly participating user. This allows the content data in which the user character of the newly participating user is placed in the virtual space to be distributed, and allows the user character to be reflected and displayed at the first position (e.g., an audience seat, in front of the desk, or outfield) in the virtual space on the user terminal of a user who is participating in the content. Furthermore, the user terminal of the newly participating user receives the comment history information and thereby specifies and displays the comment history posted in the content in which the user has participated. The first position is determined to be a position according to the type of the second mode of content. A user character corresponding to a user who is not a related SP user is displayed in a manner (e.g., size, and color) according to the type of the second mode content, and may not be displayed depending on the type of content.

If it is determined in step S31 that the newly participating user is a related SP user, the process proceeds to step S33 to place a user character corresponding to the participating related SP user at a second position (e.g., on the stage, and on the platform) in the virtual space of the content, and output comment history information for specifying the comment history of the content (see FIG. 6B) to the user terminal of the newly participating user. Then, the process proceeds to step S34. This allows the content data in which the user character of the newly participating related SP user is placed in the virtual space to be distributed, and allows the user character of the related SP user, who becomes the main character or the subject, to be reflected and displayed at the second position in the virtual space on the user terminal of a user who is participating in the content. Furthermore, the user terminal (distribution user terminal 400 in this case) of the newly participating related SP user receives the comment history information and thereby specifies and displays the comment history posted in the content in which the user has participated. The second position is determined to be a position according to the type of the second mode of content. A user character corresponding to a related SP user is displayed in a manner (e.g., size, and color) according to the type of the second mode content.

In step S34, the process makes a determination as to whether a comment has been posted on the content from any of the participating users, that is, whether comment posting information has been received. If it is not determined that comment posting information has been received, the comment control process ends. If it is determined that the comment posting information has been received, the process proceeds to step S35 to make a determination as to whether, based on the NG-related information in FIG. 7C, the user who posted the comment is a user who satisfies the prohibition condition for the type of the related SP user who is related to the content. If it is determined in step S35 that the user who posted the comment is a user who satisfies the prohibition condition for the type of the related SP user, the comment control process ends. If it is not determined in step S35 that the user who posted the comment is a user who satisfies the prohibition condition for the type of the related SP user, the process proceeds to step S36 to make a determination as to whether multiple related SP users who are related to the content have been defined. In step S36, it is determined whether multiple related SP users are defined to be related to the content, rather than whether related SP users are participating.

If it is not determined in step S36 that multiple related SP users are defined, the process proceeds to step S37 to make a determination as to whether the received comment contains the default NG for the type of the related SP user shown in FIG. 7B or contains the individual NG for the related SP user shown in FIG. 7C. In step S37, it is determined whether a NG set for the related SP user is included, regardless of whether a related SP user is participating.

If it is not determined in step S37 that either the default NG of the type of the related SP user or the individual NG of the related SP user is included in the comment specified from the comment posting information, the process proceeds to step S38 to make a determination as to whether the comment (received comment) specified from the comment posting information includes a default NG common to all users shown in FIG. 7A. If it is not determined in step S38 that the default NG common to all users is included, the process adds the received comment to the comment history of the content for updating in step S39. In step S40, the process distributes comment information to specify the received comment to the user terminals of participating users (excluding the user terminal of the user who posted the comment). This allows the posted comment to be reflected in the virtual space. As described above, on the user terminal of the user who posted the comment, the comment is reflected in the virtual space of the content that is displayed on the user terminal of the user at the time when the comment was input.

If it is determined in step S38 that the default NG common to all users is included, the comment control process ends. This is because the second mode of content has a defined related SP user who becomes the main character/subject, and thus the topic of comments will be directed at or about the related SP user. This makes it unlikely that the topic will become conversations (comment exchanged) between participating users. In that case, there is a high probability that not reflecting comments that include default NGs will not create an awkward feeling. This reduces the processing load. Depending on the type of the second modes of content, if it is determined in step S38 that a default NG common to all users is included, a process similar to steps S21 to S23 in FIG. 8 may be performed to reflect a comment in which the part of message corresponding to the default NG is replaced with a symbol, for example, and inform the user who posted the comment of as such.

If it is determined in step S37 that either the default NG of the type of the related SP user or the individual NG of the related SP user is included in the comment specified from the comment posting information, the process proceeds to step S44 to update the NG-related information on the user who posted comment, regardless of whether the related SP user is actually participating in the content (i.e., also when the related SP user does not participate). This makes it possible to specify the NG word included in the comment and the related SP user who set the word as the NG word to be restricted (including the case of setting the type-specific NG) as NG history from the NG-related information of the user who posted the comment.

If it is determined in step S37 that either the default NG of the type of the related SP user or the individual NG of the related SP user is included in the comment specified from the comment posting information, the restriction control may be made different depending on whether the related SP user is actually participating in the content, for some types of the second mode of content. For instance, if a related SP user is not actually participating in the content, processing similar to steps S21 to S22 in FIG. 8 may be performed to reflect the comment in which the part of message corresponding to the NG word is replaced with a symbol, for example, and then the process may proceed to step S44. If a relevant SP user is actually participating in the content, the process may proceed to step S44 without reflecting the comment. This makes it possible to vary the degree of regulation and restriction depending on whether or not a related SP user is actually participating.

In step S45, the process makes a determination as to whether the prohibition condition for the related SP user is satisfied based on the NG-related information of the user who posted the comment. For instance, it is determined whether the number of times the NG word has been posted to the related SP user has reached a predetermined number. If it is not determined in step S45 that the prohibition condition is satisfied, the comment control process ends. If it is determined in step S45 that the prohibition condition is satisfied, the prohibition condition information is updated in step S46 to specify the type of related SP user who is a target of the prohibition condition being satisfied. This prevents the user who posted the comment from posting a comment within the virtual space of content that is related to a SP user of the type that is specified from the prohibition condition information.

If it is determined in step S36 that multiple related SP users are defined, the process proceeds to step S43 to make a determination as to whether the comment identified from the comment posting information contains the default NG for the type of the related SP user shown in FIG. 7B. If multiple related SP users are defined, there may be a case where even if it is a NG word for one related SP user, the other related SP user may wish to reflect it in order to enhance the atmosphere in the content, or a case where strict restriction causes too small number of comments reflected because the number of individual NG words will increase. In consideration of these cases, the individual NG of the related SP user shown in FIG. 7C, for example, is excluded from the restriction target. If the types of multiple related SP users are different, it is determined in step S43 whether any of the default NGs for each type is included. The present invention is not limited to this. If the types of multiple related SP users are different, it may be determined in step S43 as to whether a common default NG is included among the default NGs of these types, or it may be determined whether one of the default NGs is included among the default NGs of these types.

If it is not determined in step S43 that the comment specified from the comment posting information contains a default NG for type of the related SP user, the process proceeds to step S38. If it is determined that the comment contains a default NG for the type of the related SP user, the process proceeds to step S44. Note that step S43 is not limited to this as long as it may perform restriction control different from that performed when there is only one related SP user in order to prevent the number of NGs from becoming too large. For instance, the type-specific NG of the related SP user shown in FIG. 7B may be excluded from the restriction target, and it may be determined whether individual NGs set for each of the multiple related SP users are included.

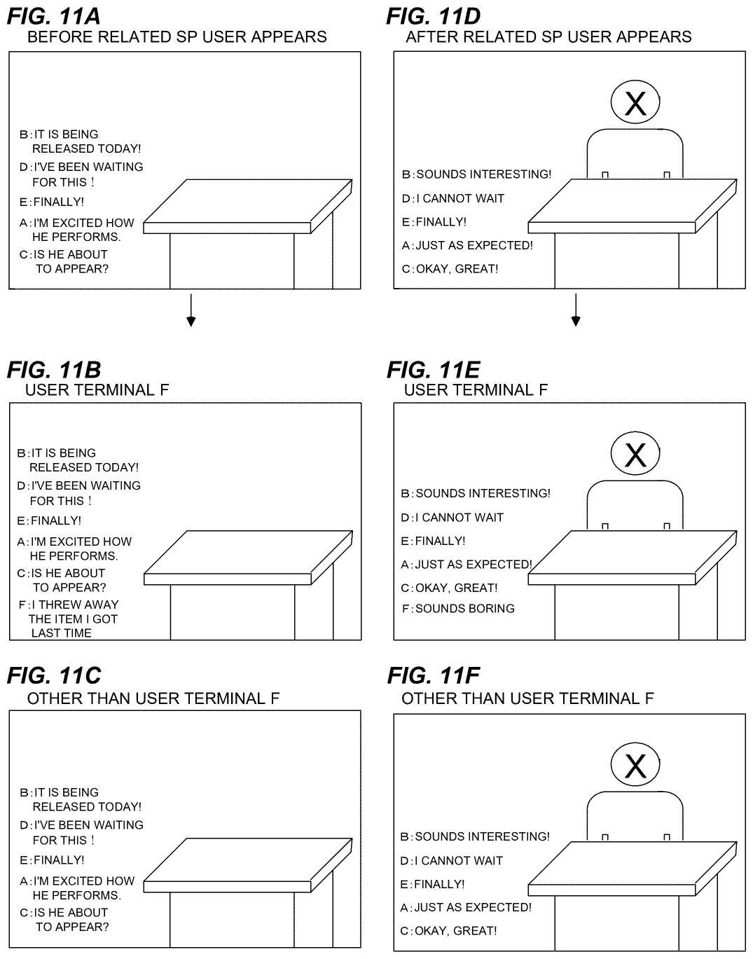

FIG. 11A through FIG. 11F illustrate display examples of a user terminal during the distribution of a second mode of content. FIG. 11A to FIG. 11F show display examples of a user terminal participating in program content of performer X, which is one of the second modes of content. For instance, this program content includes: a first part in which fans of performer X gather to exchange information about performer X before the performer X appears; and a second part in which performer X appears at a certain time (such as timing determined in advance by the operator or at any timing of performer X's choice) to further liven up the atmosphere. Performer X is a user who is defined to be related to this program content.

FIG. 11A through FIG. 11C show examples of display during the first part in which performer X has not appeared. As shown in FIG. 11A, the user terminal of a user participating in the program content displays a desk object by which performer X stands when they appear, from the center area to the right area of the screen, and displays a history of a predetermined number of comments most recently posted on the program content in the left area of the screen. Although FIG. 11A shows an example in which the user character of a participating user is not displayed in the virtual space, the user character may be displayed in the virtual space depending on the type of content.

FIG. 11A shows comments posted in the order of users B, D, E, and A from the comment history, and a comment such as “Is he about to show up?” posted by user C. When a comment is posted, the content of the comment is displayed next to the user name in the comment history. This allows the users to be informed of the most recently posted comment in an easily understandable manner.

Following the comment posted from user C, FIG. 11B shows an example of the display on user terminal F of user F when user F posted a comment such as “I threw away the item I got last time . . . ”, and FIG. 11C shows an example of the display on a user terminal of a user other than user F who posted the comment. On user terminal F of the user F who posted the comment, the posted comment is reflected in the virtual space regardless of whether the comment contains a NG word when posted it, as described above. A user terminal of a user other than the user who posted the comment receives the comment information transmitted in step S40 in FIG. 10, and has the posted comment reflected in the virtual space. It is assumed that performer X has set words that evoke negative or passive impressions as NG words, and these include “throw away” and “discard.” Furthermore, regardless of whether performer X is participating in the content (even if they have not yet participated), when a comment is posted, a determination such as step S37 in FIG. 10 is made. The comment posted by user F includes a NG word set by performer X. Thus, it is determined YES in step S37 in FIG. 10, so that comment information is not transmitted in step S40 of FIG. 10. Therefore, as shown in FIG. 11C, the comment from user F is not displayed on user terminals of users other than user F.

FIG. 11D through FIG. 11F show examples of display during the second part in which performer X appears. As shown in FIG. 11D, the user terminal of a user participating in the program content displays a desk object by which performer X stands, from the center area to the right area of the screen, and displays a history of several comments most recently posted to the program content in the left area of the screen. FIG. 11D shows comments posted in the order of users B, D, E, and A from the comment history, and a comment such as “Okay, great!” posted by user C.

Following the comment posted from user C, FIG. 11E shows an example of the display on user terminal F of user F when user F posted a comment such as “Sounds boring . . . ”, and FIG. 11F shows an example of the display on a user terminal of a user other than user F who posted the comment. On user terminal F of user F who posted the comment, the posted comment is reflected in the virtual space regardless of whether the comment contains a NG word when posted. A user terminal of a user other than the user who posted the comment receives the comment information transmitted in step S40 in FIG. 10, and has the posted comment reflected in the virtual space. It is assumed that performer X has set words that evoke negative or passive impressions as NG words, and these include “boring” and “sounds boring.” Furthermore, regardless of whether performer X is participating in the content, when a comment is posted, a determination such as step S37 in FIG. 10 is made. The comment posted by user F includes a NG word set by performer X. Therefore, as shown in FIG. 11F, the comment from user F is not displayed on user terminals of users other than user F.

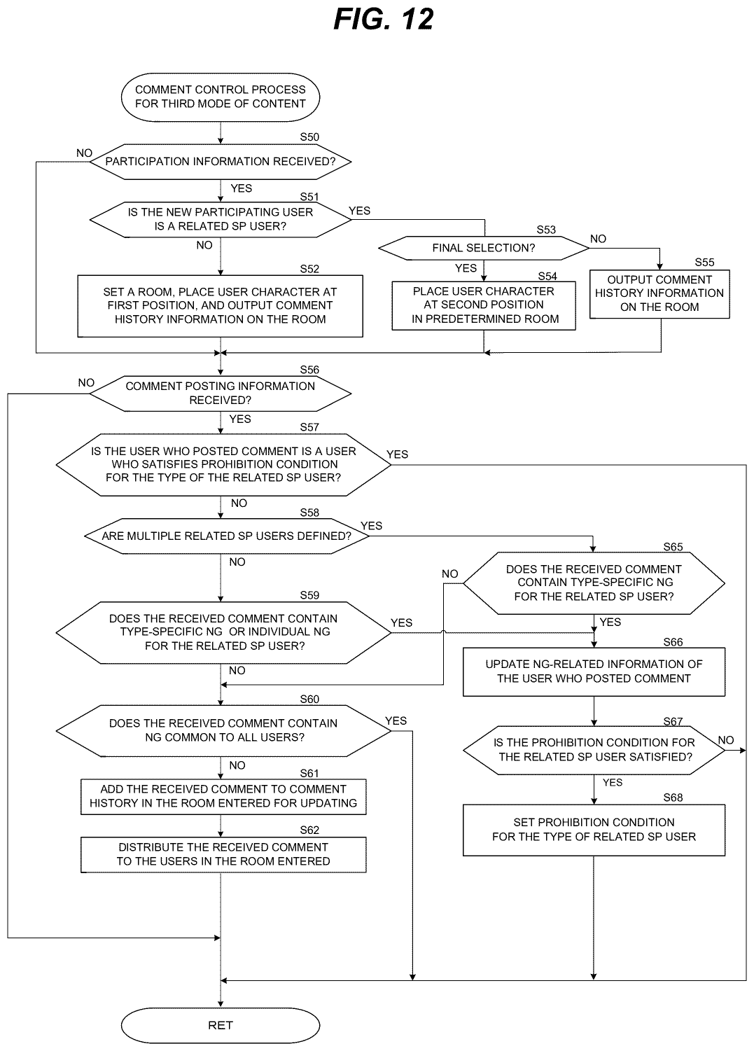

FIG. 12 is a flowchart of the comment control process during distribution of a third mode of content. The comment control process during distribution of a third mode of content is executed for each piece of content, and is repeatedly executed by the controller 130 of the distribution server 100 at predetermined time intervals. The distribution server 100 performs various processes including the comment control process during distribution of a third mode of content on the basis of the program stored in the storage unit 120.

First, in step S50, the process makes a determination as to whether participation information has been received from a user terminal. If it is not determined that participation information has been received, the process proceeds to step S56. If it is determined that the participation information has been received, the process makes a determination in step S51 as to whether the new participating user is a related SP user (e.g., distribution user, or SP user) who is a user who becomes the main character or the subject of the content being distributed and is relevant to the content. In step S51, it is determined whether the user ID is of the related SP user, which is stored for each piece of content shown in FIG. 6C.

If the user is not determined to be a related SP user in step S51, the process proceeds to step S52. Then, the process sets and stores a room to which the user is to enter among multiple rooms corresponding to the content (see FIG. 6C), and places a user character corresponding to the user at a first position (e.g., an audience seat) in the virtual space of the room, and outputs comment history information for specifying the comment history of the room (see FIG. 6C) to the user terminal of the participating user. This allows the content data in which the user character of the newly participating user is placed in the virtual space of the room to be distributed, and allows the user character to be reflected and displayed at the first position in the virtual space in the room on the user terminal of a user who is in the room (is participating) in the content. Furthermore, the user terminal of the newly participating user receives the comment history information and thereby specifies and displays the comment history posted in the content in which the user has participated. The first position is determined to be a position according to the type of the third mode of content. A user character corresponding to a user who is not a related SP user is displayed in a manner (e.g., size, and color) according to the type of the third mode content, and may not be displayed depending on the type of content.

If the user is determined to be a related SP user in step S51, the process proceeds to step S53 to make a determination as to whether the user enters the selected room (i.e., whether the selection is final). For the third mode of the content, an example is shown, in which a related SP user is allowed to select the room they want to enter. Specifically, they provisionally select one of the rooms, check the room including the comment history, and then make a final selection to enter the room.

If it is not determined in step S53 that the selection is final, then this is a provisional selection for the purpose of checking the room and others. Thus, the process proceeds to step S55 to output comment history information for specifying the comment history (see FIG. 6C) of the provisionally selected room to the user terminal of the related SP user. Then, the process proceeds to step S56. This allows the user terminal (distribution user terminal 400 in this case) of the related SP user who made a provisional selection to receive the comment history information and thereby specify and display the comment history posted in the provisionally selected room. Furthermore, while the related SP user is checking the provisionally selected room, the user character of the related SP user will not be displayed in the room. This allows the related SP user, who made a provisional selection, to check each of the multiple rooms without displaying their user character in the rooms. The room that is provisionally selected first may be one selected by the related SP user, or may be one selected by the distribution server 100. When selected by the distribution server 100, the room with the largest number of users may be selected, or the room with a predetermined number (e.g., 20) or more users in the room may be randomly selected. This will make it easier for the related SP user to understand the level of interaction and excitement within the provisionally selected room based on the status of comment postings, for example. The related SP user may provisionally select a room and check the room, and then provisionally select another room to change the room to be checked.

If it is determined in step S53 that the selection is final, then the process proceeds to step S54 to place a user character corresponding to the related SP user who made a final selection at a second position (e.g., on the stage, and on the platform) in the virtual space of the predetermined room. Then, the process proceeds to step S56. This allows the content data in which the user character of the newly participating related SP user is placed in the virtual space of the predetermined room, and allows the user character of the related SP user, who becomes the main character or the subject, to be reflected and displayed at the second position in the virtual space of each room on the user terminals of users who are in the predetermined room.

The related SP user finally selects the provisionally selected room, which makes the user character of the related SP user displayed in the predetermined room as described above. The predetermined room in which the user character of the related SP user is displayed is defined according to the type of content. For live event content, for example, a plurality of rooms corresponding to the live event content are all set as predetermined rooms, and the user character of the related SP user is mirrored in each of the plurality of rooms and reflected in each room. For fan meeting content, for example, a room finally selected by a particular performer, for example, is set as a predetermined room, and the user character of the related SP user is reflected only in the room. Even after the final selection, this final selection may be cancelled, and another room may be provisionally selected for the final selection (change the selected room). After the final selection, until the cancellation of the final selection and a provisional selection of another room for the final selection, the display of the user character of the related SP user may be maintained for live event content. For fan meeting content, the user character of the related SP user may be made invisible in response to the cancellation of the final selection, and then the user character may be reflected in the finally selected room.

The comment history of the finally selected room has already been displayed in step S55 on the user terminal of the relevant SP user. The second position is determined to be a position according to the type of the third mode of content. The user character corresponding to the related SP user is displayed in a manner (e.g., size, and color) according to the type of the third mode content. Note that, after the content starts, if the related SP user makes a provisional selection to check the virtual space of the content, including the comment history, and then makes a final selection to make the user character appear in the virtual space, then steps S53 to S55 in FIG. 12 may not be executed (the room cannot be selected again). Steps S53 to S55 in FIG. 12 may be applied to the second mode of content described above. For the second mode of content, the related SP user may make a provisional selection to check the virtual space of the content, including the comment history, and then make a final selection to make the user character appear in the virtual space, for example.

In step S56, the process makes a determination as to whether a comment has been posted in any of the rooms, that is, comment posting information has been received, regardless of whether this is the room which the related SP user has selected and entered. If it is not determined that comment posting information has been received, the comment control process ends. If it is determined that the comment posting information has been received, the process proceeds to step S57 to make a determination as to whether, based on the NG-related information in FIG. 7C, the user who posted the comment is a user who satisfies the prohibition condition for the type of the related SP user who is related to the content. If it is determined in step S57 that the user who posted the comment is a user who satisfies the prohibition condition for the type of the related SP user, the comment control process ends. If it is not determined in step S57 that the user who posted the comment is a user who satisfies the prohibition condition for the type of the related SP user, the process proceeds to step S58 to make a determination as to whether multiple related SP users who are related to the content have been defined.

If it is not determined in step S58 that multiple related SP users are defined, the process proceeds to step S59 to make a determination as to whether the received comment contains the default NG for the type of the related SP user shown in FIG. 7B or contains the individual NG for the related SP user shown in FIG. 7C.

If it is not determined in step S59 that either the default NG of the type of the related SP user or the individual NG of the related SP user is included in the comment specified from the comment posting information, the process proceeds to step S60 to make a determination as to whether the received comment includes a default NG common to all users shown in FIG. 7A. If it is not determined in step S60 that a default NG common to all users is included, the process proceeds to step S61 to add the received comment to the comment history of the room in which the user who posted the comment is participating for updating. In step S62, comment information for specifying the received comment is distributed to user terminals of users (excluding the user terminal of the user who posted the comment) participating in the same room (the room in which the user who posted the comment is present). This allows the posted comment to be reflected in the virtual space of the same room as the user who posted the comment. As described above, on the user terminal of the user who posted the comment, the comment is reflected in the virtual space of the room displayed on the user terminal of the user at the time when the comment was input.

If it is determined in step S60 that a default NG common to all users is included, the comment control process ends. This is for the same reason as explained in step S38 of FIG. 10. Depending on the type of the third mode of content, if it is determined in step S60 that a default NG common to all users is included, a process similar to steps S21 to S23 in FIG. 8 may be performed to reflect a comment in which the part of message corresponding to the default NG is replaced with a symbol, for example, and inform the user who posted the comment of as such.

If it is determined in step S59 that the received comment contains a default NG for the type of the related SP user or an individual NG for the related SP user, the process proceeds to step S66 to update the NG-related information on the user who posted the comment, regardless of whether the related SP user is actually participating in the content, and even if the related SP user is participating, regardless of whether the post is from a user who is in the same room as the related SP user. This makes it possible to specify the NG word included in the comment and the related SP user who set the word as the NG word to be restricted (including the case of setting the type-specific NG) as NG history from the NG-related information of the user who posted the comment.

If it is determined in step S59 that either the default NG of the type of the related SP user or the individual NG of the related SP user is included in the comment specified from the comment posting information, the restriction control may be made different depending on whether the related SP user is actually participating in the content, for some types of the third mode of content. For instance, if a related SP user is not actually participating in the content, processing similar to steps S21 to S22 in FIG. 8 may be performed to reflect the comment in which the part of message corresponding to the NG word is replaced with a symbol, for example, and then the process may proceed to step S66. If a relevant SP user is actually participating in the content, the process may proceed to step S66 without reflecting the comment. This makes it possible to vary the degree of regulation and restriction depending on whether a related SP user is actually participating.

In step S67, the process makes a determination as to whether the prohibition condition for the related SP user is satisfied based on the NG-related information of the user who posted the comment. If it is not determined in step S67 that the prohibition condition is satisfied, the comment control process ends. If it is determined in step S67 that the prohibition condition is satisfied, the prohibition condition information is updated in step S68 to specify the type of related SP user who is a target of the prohibition condition being satisfied. This prevents the user who posted the comment from posting a comment within the virtual space of content that is related to a SP user of the type that is specified from the prohibition condition information.

If it is determined in step S58 that multiple related SP users are defined, the process proceeds to step S65 to make a determination as to whether the comment contains the default NG for the type of the related SP user shown in FIG. 7B. This is for the same reason as explained in step S43 of FIG. 10. If it is not determined in step S65 that the received comment contains a default NG for type of the related SP user, the process proceeds to step S60. If it is determined that the comment contains a default NG for the type of the related SP user, the process proceeds to step S66.

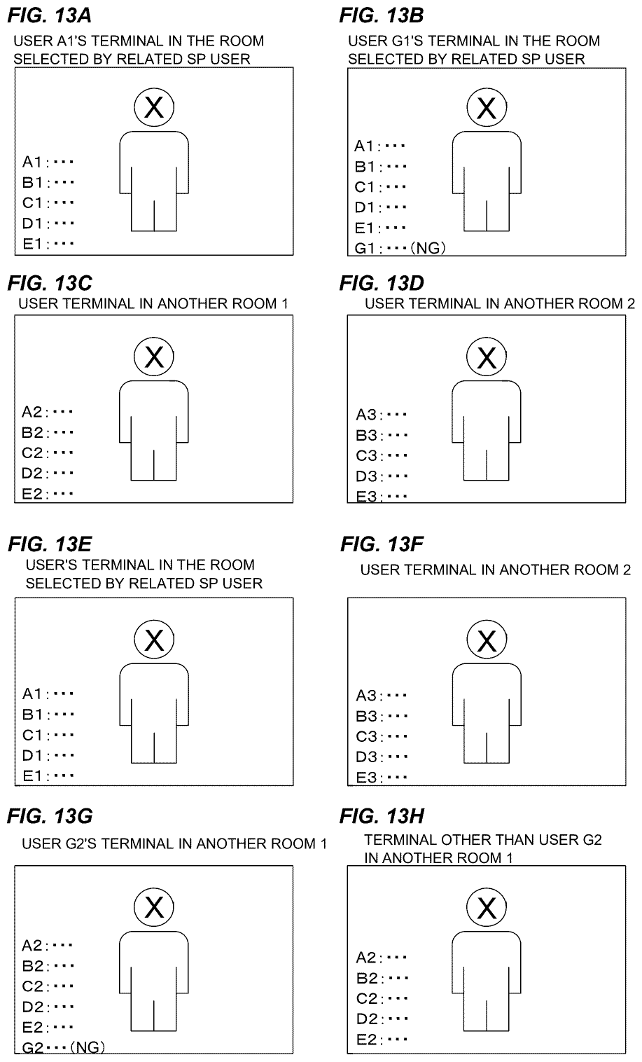

FIG. 13A through FIG. 13H illustrate display examples of a user terminal during the distribution of a third mode of content. FIG. 13A to FIG. 13H show display examples of user terminals of a plurality of users participating in live event content by performer X, which is one of the third modes of content. In the live event content, as shown in FIG. 13A, for example, a user character of performer X as the main character is placed in the center area of the screen, and the history of a predetermined number of comments most recently posted to the room in which the user of the user terminal is displayed on the left area of the screen. In the live event content, the user character of performer X is mirrored and reflected in all of the multiple rooms corresponding to that content.

FIG. 13A shows a display example of a user terminal of user A1 who is in the same room as the room selected by performer X, and FIG. 13B shows a display example of a user terminal of user G1 who is in the same room as the room selected by performer X. It is assumed that users A1 to Z1 have entered the room selected by performer X. The comment history shown in FIG. 13A shows that comments were posted by users A1, B1, C1, D1, and E1 in that order.

FIG. 13C and FIG. 13D show a display example of a user terminal of a user who has entered a room different from the room selected by performer X. It is assumed that, as shown in FIG. 13C, users A2 to Z2 have entered room 1 that is different from the room selected by performer X. The comment history shows that comments were posted by users A2, B2, C2, D2, and E2 in that order. It is assumed that, as shown in FIG. 13D, users A3 to Z3 have entered room 2 that is different from the room selected by performer X. The comment history shows that comments were posted by users A3, B3, C3, D3, and E3 in that order.

The following describes a case, as shown in FIG. 13B, where user G1, who is in the same room as the room that performer X has selected, posts a comment containing the NG word that performer X has set. On user terminal of user G1 who posted the comment, the posted comment is reflected in the virtual space regardless of whether the comment contains a NG word when posted it, as described above. A user terminal of a user other than the user who posted the comment and who is in the same room (including performer X) receives the comment information transmitted in step S62 in FIG. 12, and reflects the posted comment in the virtual space. However, the comment posted by user G1 contains a NG word set by performer X, and thus it is determined YES in step S59 of FIG. 12 and comment information is not transmitted in step S62 of FIG. 12. Thus, on the user terminal of a user who is in the same room as user G1, the comment from user G1 is not displayed, as shown in FIG. 13A. For a user terminal of a user who is in a different room from user G1, the comment from user G1 will not be displayed as shown in FIG. 13C and FIG. 13D, regardless of whether the comment posted by user G1 contains a NG word.

FIG. 13E to FIG. 13H show a case immediately before the comment from user G1 shown in FIG. 13B is posted, and when a comment including a NG word set by performer X was posted by user G2 who is in room 1 different from the room that performer X has selected. On user terminal of user G2 who posted the comment, as shown in FIG. 13G, the posted comment is reflected in the virtual space regardless of whether the comment contains a NG word when posted it.

A user terminal of a user other than the user who posted the comment and who is in the same room receives the comment information transmitted in step S62 in FIG. 12, and reflects the posted comment in the virtual space. However, the comment posted by user G2 contains a NG word set by performer X, and thus it is determined YES in step S59 of FIG. 12 and comment information is not transmitted in step S62 of FIG. 12. Thus, on the user terminal of a user who is in the same room as user G2, the comment from user G2 is not displayed, as shown in FIG. 13H. Note that, for a user terminal of a user who is in a different room from user G2, the comment from user G2 will not be displayed as shown in FIG. 13E and FIG. 13F, regardless of whether the comment posted by user G2 contains a NG word.

### Example of Specific Configurations and Advantageous Effects Relating to NG Word Restrictions

(1-1) In the above embodiment, in accordance with a program (e.g., a program stored in a non-transitory computer-readable storage medium) stored in the distribution server computer 100 and a user terminal, during distribution of any of first modes of content, if it is determined that no SP user is participating in a virtual space of the content in step S15 of FIG. 8, and even if the posted comment includes a NG word set for any SP user, the received comment is reflected in the virtual space in step S20 of FIG. 8. In contrast, during distribution of any of first modes of content, if it is determined that a SP user is participating in a virtual space of the content in step S15 of FIG. 8 (including the case where a SP user, who was not participating, is participating there), and if the posted comment includes a NG word set for the SP user who is participating, the process determines YES in step S17 of FIG. 8, and reflection of the received comment in the virtual space is restricted. This enables appropriate restriction of the reflection of a comment including a NG word set for the SP user, depending on whether the SP user is included in the virtual space of the content.

(1-2) In the above embodiment, the comment posted in the content is added to the comment history for updating in step S19 of FIG. 8, for example. If a new user participates in the content, comment history information is output to the user terminal of the user to enable the comment history to be displayed in step S12 of FIG. 8. If a SP user who has not participated in the content newly participates, a comment including a NG word set for the SP user is deleted from the comment history for updating in step S13 of FIG. 8, and the comment history information after the deletion and updating is output. This prevents the comment history including the NG word from being reflected and displayed on the SP user's user terminal when the SP user newly participates.

(1-3) The above embodiment describes an example where the NG setting unit 253 sets a NG word candidate that is proposed from a SP user who is participating in the virtual space of certain content (including the case where the user themselves is distributing the content) as a NG word for such SP user without waiting for the setting from the operator. The above example shows that, with the input information transmission unit 356, the SP user themselves drags and highlights a part of the message to be used as a candidate NG word from the comment reflected in the comment history in the virtual space of the content in which they are participating, thus applying for setting the NG word. These reduce the time and effort required to set a NG word and improve convenience for a SP user.

(2-1) In the above embodiment, in accordance with a program (e.g., a program stored in a non-transitory computer-readable storage medium) stored in the distribution server computer 100 and a user terminal, if a comment including a NG word set for any SP user is posted by multiple users participating in a first mode content that is not related to the SP user and does not satisfy a special condition for the SP user, and if the SP user is not actually participating, the comment is reflected in the virtual space of the content in step S20 of FIG. 8. In contrast, if a comment including a NG word set for any SP user is posted by multiple users participating in a second mode of content or a third mode content that is related to the SP user and satisfies a special condition for the SP user, it is determined YES in step S37 of FIG. 10, regardless of whether the SP user is actually participating, and thus reflection of the comment including the NG word is restricted in the virtual space of the content. This appropriately restricts the reflection of a NG word set for a SP user according to the type of content.

(2-2) The above embodiment shows an example of content that satisfies the special condition, including content where a related SP user appears there to initiatively distribute the content, and content where a related SP user does not appear and fans of the related SP user gather to communicate with each other. In any type of the content, it makes it possible to prevent a NG word from being reflected before the relevant SP user is included in the content, or a NG word from being reflected if the content is predetermined to be relevant to the SP user.

(2-3) In the above embodiment, content related to a SP user belonging to SP1 and content related to a SP user belonging to SP2 contain different words as NG words. This allows NG words to be appropriately differentiated according to the type of related SP user and content type.

(3-1) In the above embodiment, in accordance with a program (e.g., a program stored in a non-transitory computer-readable storage medium) stored in the distribution server computer 100 and a user terminal, if it is determined Yes in step S37 of FIG. 10, for example, the reflection of the received comment is restricted, and the NG-related information of each user is updated in step S44 of FIG. 10. Further, if it is determined based on the NG-related information in step S35 of FIG. 10, for example, that the user who posted the comment is a user who satisfies the prohibition condition for the type of the related SP user, the reflection of the comment is restricted, regardless of whether the comment contains a NG word or whether the SP user who caused the prohibition condition to be satisfied is participating. In this way, NG-related information updated for each user is utilized in the content that is relevant to SP users belonging to the same type, and reflection of a comment from a prohibited user who satisfies the prohibition condition according to NG-related information is restricted.

(3-2) In the above embodiment, for example, if a prohibited user who satisfies the prohibition conditions for SP1 is included among users participating in content related to SP users belonging to SP2, and when a comment is posted from the prohibited user, the comment from the prohibited user is reflected if the prohibition condition for SP2 is not satisfied. This prevents NG-related information updated for each user from being utilized and used also for content that is relevant to SP users belonging to different types, and prevents excessive restrictions of the reflection.

(4-1) In the above embodiment, in accordance with a program (e.g., a program stored in a non-transitory computer-readable storage medium) stored in the distribution server computer 100 and a user terminal, in content that satisfies a special condition for any SP user, if a comment containing a NG word set for the SP user is posted, the reflection of the comment is restricted, and a type-specific NG is set in advance for a type of SP users, where different words are included between for a SP user belonging to type SP1 and a SP user belonging to type SP2. This allows appropriate restriction of words according to the type of a SP user without the trouble in setting NG words.

(4-2) In the above embodiment, for example, assume a situation where related SP users who are defined to be relevant to the content include a SP user belonging to type SP1 and a SP user belonging to type SP2. As exemplified in step S43 of FIG. 10, the reflection is restricted based on the type-specific NG, not based on individual NG words that are set individually for each of the multiple SP users. In this way, the process for restricting the reflection (restriction control) may be different depending on whether multiple related SP users are included.

(5-1) In the above embodiment, in accordance with a program (e.g., a program stored in a non-transitory computer-readable storage medium) stored in the distribution server computer 100 and a user terminal, in a third mode of content in which multiple rooms (multiple virtual spaces) are prepared to provide a single piece of content, if a comment containing an NG word is posted in one of the rooms, the reflection of the comment is restricted regardless of whether the comment was posted in a room selected by a related SP user of the content. This enables appropriate restriction of the reflection of a comment containing a NG word also in the third mode of content.

(5-2) For the case of live event content in the above embodiment, an example is shown, in which a user character corresponding to the related SP user is displayed in all multiple rooms corresponding to the live event content, regardless of whether the room is selected by the related SP user. This allows users entering any room to recognize and see the user character corresponding to the related SP user, thus creating a sense of unity in all rooms.

(5-3) For the case of fan meeting content in the above embodiment, an example is shown, in which a user character corresponding to the related SP user is displayed in the room selected by the related SP user. This increases the sense of anticipation and premium feeling regarding the display of the user character corresponding to the related SP user.

(5-4) In the above embodiment, as shown in step S55 of FIG. 12, the related SP user is able to check the state including the comment history in the provisionally selected room. Also, as shown in step S54 in FIG. 12, the user character corresponding to the related SP user is not displayed until the related SP user makes a final selection. This allows the related SP user to understand the state of a room without being aware of the user character by other users in the room, and the related SP user is able to use this for a reference as to whether or not to select this room and enter the room.

(5-5) The above embodiment shows an example, in which when the distribution server 100 selects a room to be provisionally selected first, it may select the room with the largest number of users, or may randomly select a room with a predetermined number (e.g., 20) or more users in the room. This will make it easier for the related SP user to understand the level of interaction and excitement within the provisionally selected room based on the status of comment postings, for example.

(5-6) The above embodiment shows an example, where after provisionally selecting a room and checking it, the user is able to provisionally select another room and change the room to be checked, and that even after a room has been finally selected, the user is able to cancel the final selection and provisionally select another room and change the room to be selected (change the selected room). This allows a related SP user to change the rooms to be checked one after another, thereby improving the convenience of the related SP user.

(6) The above embodiment shows an example, in which a user who has a specific relationship includes a participating user (a user who participates in a group of certain content) associated with common content (group). This enables restriction of the reflection of a NG word among users associated with common content.

(7) In the above embodiment, during distribution of a first mode of content, if a default NG common to all users is included in the received comment, the default NG of the comment is replaced with a symbol, for example, in step S22 of FIG. 8, and the comment other than the default NG is reflected. If a NG word set for a participating SP user is included in the received comment, it is determined YES in step S17 of FIG. 8 to restrict the reflection of the comment itself including the NG word. This will restrict the reflection of a predefined default NG common to all users to a minimum extent, and thus prevents inconveniences such as a failure to carry on the conversation because reflection of a comment that contains a word that the SP user has not specified as a restriction target is restricted.

(8) In the above embodiment, during distribution of a second mode of content or a third mode of content, if it is determined in step S37 of FIG. 10 that either the default NG of the type of the related SP user or the individual NG of the related SP user is included in the comment specified from the comment posting information, and if the related SP user is not actually participating, the process similar to steps S21 to S22 of FIG. 8 is performed to reflect a comment with the part of message corresponding to the NG word with a symbol, for example, and the process proceeds to step S44. If it is determined in step S37 of FIG. 10 that either the default NG of the type of the related SP user or the individual NG of the related SP user is included in the comment specified from the comment posting information, and if the related SP user is actually participating the content, the process proceeds to step S44 without reflecting the comment itself. This makes it possible to, during distribution of a second mode of content or a third mode of content, vary the degree of restriction depending on whether a related SP user is actually participating.

(9) In the above embodiment, when a SP user performs an operation to apply for setting a new NG word, and if the application is accepted by the operator, this candidate is set as an individual NG for the SP user by the NG setting unit 253. This prevents the use of too many NG words because a word that is accepted by the operator is set as a NG word.

(10) In the above embodiment, as shown in FIG. 8, for example, NG words include: a default NG common to all users, where, if the reflection of a default NG is restricted, the user who posted the comment including the word is notified of the restriction; and an individual NG, where the user is not informed of the restriction. In step S23 of FIG. 8, process is performed to inform the user who posted the comment containing the default NG common to all users that reflection of the comment has been restricted because it is a NG. This will prevent repeated posting of the default NG common to all users.

(11) In the above embodiment, the comment is reflected on the user terminal of the user who posted the comment, regardless of whether the comment contains an NG word, and the comment posting information is output to the user terminal (e.g., see FIG. 9E), while the distribution server 100 outputs comment information for a comment that does not contain a NG word to reflect the comment in the virtual space of the content, but does not output comment information for a comment containing a NG word to restrict the reflection (e.g., see FIG. 9F). This prevents the user who posted the comment from being able to know whether the comment was actually reflected, and thus prevents the user from specifying the NG word and posting a comment in a way that circumvents the restrictions.

(12) In the above embodiment, a common default NG is set in advance for each type of SP user as shown in FIG. 7B. For instance, an example is shown, in which between step S16 and step S17 of FIG. 8, a determination may be made whether the content includes a plurality of SP users. In this example, if it is not determined that the content includes a plurality of SP users, the process proceeds to step S17, and if it is determined that a plurality of SP users is included, then the process makes a further determination as to whether the received comment contains a type-specific NG for each of these SP users, and if the type-specific NG is not included, the process proceeds to step S18. If the type-specific NG is included, the process may restrict the reflection and proceed to step S24. This prevents too few comments reflected when multiple SP users are included.

(13) In the above embodiment, when a related SP user is included among the participating users, the actions that the related SP user may take are different from the actions (e.g., posting a comment) that can be taken by users (e.g., general users or other SP users) other than the related SP user. For example, when the related SP user is initiatively distributing content, the related SP user cannot post comments, but is able to make a corresponding user character, like an avatar of the related SP user, move and output sound in the virtual space. This makes the actions that can be taken by a related SP user and other users different, allowing each user to take an action appropriate to their situation.

### <Mute Restrictions>

FIG. 5 through FIG. 13H describe an example in which no users have not made a mute designation and no users are a target of full mute control. For instance, an example has been described, in which comment information is distributed to each user's user terminal 300 in steps S20 and S22 of FIG. 8, step S40 of FIG. 10, and step S62 of FIG. 12 (hereinafter they are collectively referred to as a comment distribution step) and the posted comment is reflected. However, if a mute designation has been made, comment information is not distributed in the comment distribution step, for example, to the user terminal 300 of the designation user who has designated the user who posted the comment as a mute target as described above. This is not for reflecting the posted comment on the designation user's terminal 300. Furthermore, if the user who posted the comment meets the restriction condition and is a target of full mute control, then the comment information is basically not distributed in the comment distribution step, for example, to the user terminals 300 not only of the designation user who has designated the user as a mute target but also of another user who has not designated the user as a mute target, so as not to reflect the comment posted. The following describes technical matters related to the mute.

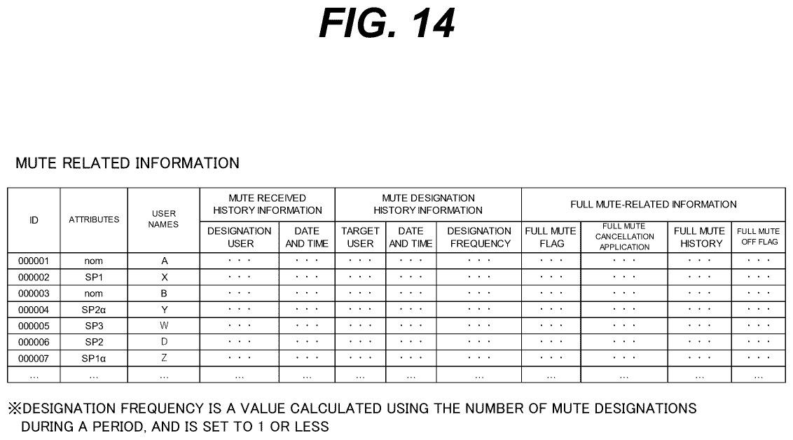

FIG. 14 describes one example of the mute related information stored in the storage unit 120 of the distribution server 100. FIG. 14 shows the mute related information stored for each user. Similar to the NG information, the mute related information for each user is stored corresponding to user information including, for example, the user ID and user name. The user name and the type of the user are stored in association with the user ID, and further, mute-received history information, mute designation history information, and full mute related information are stored as the mute related information. The mute related information may be stored together with the NG information in association with user information including a user ID and a user name.

The mute-received history information indicates a history of the user being designated as a mute target, and includes information on a designation user who designated the user as a mute target and the date and time of the designation. The mute-received history information is updated based on mute designation information and mute cancellation information from a user. The mute-received history information includes a current received history of mute designations that are made at the current timing, and a past received history of mute designations in the past but subsequently cancelled (history of designations not currently being made). Mute is determined based on the current received history, without reference to the past received history. The restriction condition is also determined based on the current received history. However, if the current received history of a certain user, who met the restriction condition in the past, does not meet the restriction condition because another user cancels the mute designation, the full mute control for the certain user will not be canceled by that alone, but is maintained thereafter.

The mute designation history information includes information for specifying another user designated by the user as a mute target, the date and time of the designation, and the designation frequency indicating how frequently the user has designated the other user as a mute target. The mute designation history information is updated based on mute designation information and mute cancellation information from a user. The mute designation history information includes a current designation history of mute designations made at the current timing, and a past designation history of mute designations in the past but subsequently cancelled (history of designations not currently being made). For instance, the designation frequency is a value calculated using the time the user has participated in any of the content during a predetermined period (e.g., one year) and the number of mute designations of other users during the period. It is set to “1” when the number of designations is 0 and approaches a lower limit (e.g., 0.1) as the number of designations increases. The designation frequency may be a value calculated based on the following expression, for example.

designation frequency=0.1+0.9×(1−number of designations/time) Mathematical Expression:

In this expression, time is, for example, the total number of “minutes” spent participating in the content. If the value of (1−number of designations/time (minutes)) is negative (such as when it is designated more than once per minute), it will be calculated as “0”.

When calculating the designation frequency based on such an expression, a user with “0” designations will have a designation frequency of “1”, and the more designations they make, the smaller the designation frequency will be; for example, a user who designates more than once per minute will have a designation frequency of the lower limit of “0.1”. The designation frequency is calculated based on the number of designations based on the current designation history over a predetermined period (e.g., one year). The present invention is not limited to this and it may be calculated by taking into account not only the number of designations based on the current designation history but also past designation history.

The full mute related information includes information for specifying: a full mute flag indicating that the user meets the restriction condition and is a target of full mute control; a full mute history indicating that the full mute control was performed for the user in the past (e.g., the number of times the full mute control was canceled, and the date it was canceled); and a full mute off flag indicating that comments from the user who is a target of full mute control will be reflected without being restricted, on the basis of the full mute selection information from the user.

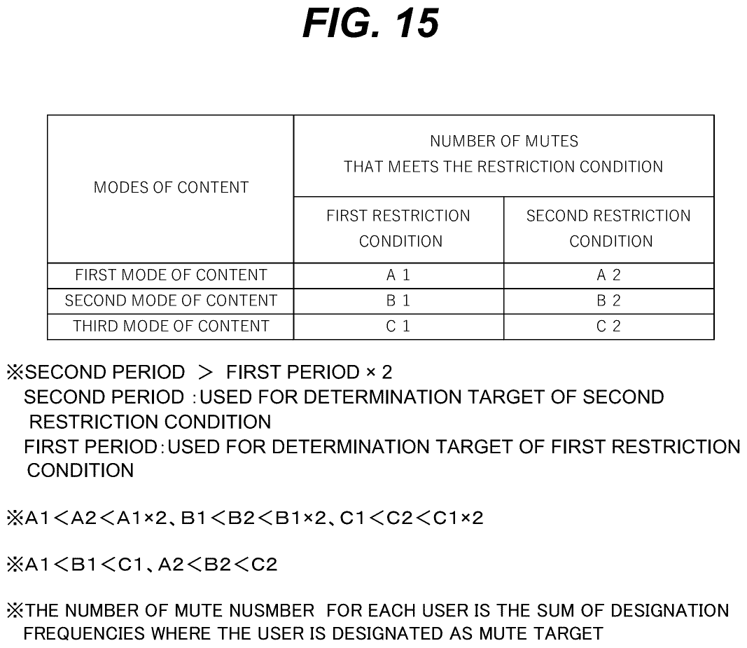

FIG. 15 describes one example of restriction conditions in the mute related information stored in the storage unit 120 of the distribution server 100. In FIG. 15, a first restriction condition and a second restriction condition are defined for each type of content, and the first restriction condition is for making a determination on a mute designated during a first period, and a second restriction condition is for making a determination on a mute during a second period that is longer than the first period. The second period is set as a period longer than twice the first period. For instance, the first period may be the most recent 24 hours and the second period may be the most recent one week (24 hours×7), or the first period may be the most recent one week and the second period may be the most recent one month (24 hours×30).

FIG. 15 also shows A1, A2, B1, B2, C1, and C2 that are the numbers of mutes that meet the restriction condition. For instance, for a user participating in a first mode of content, the user is determined to meet the first restriction condition when the number of mutes received during a first period reaches A1, and to meet the second restriction condition when the number of mutes received during a second period reaches A2. A2 is set to a value that is greater than A1 but less than twice the value of A1. For instance, A1 may be set to “20” and A2 to “35”.

For a user participating in a second mode of content, the user is determined to meet the first restriction condition when the number of mutes received during a first period reaches B1, and to meet the second restriction condition when the number of mutes received during a second period reaches B2. B2 is set to a value that is greater than B1 but less than twice the value of B1. For instance, B1 may be set to “50” and B2 to “90”

For a user participating in a third mode of content, the user is determined to meet the first restriction condition when the number of mutes received during a first period reaches C1, and to meet the second restriction condition when the number of mutes received during a second period reaches C2. C2 is set to a value that is greater than C1 but less than twice the value of C1. For instance, C1 may be set to “100” and C2 to “180”.

Here, the number of mutes that is used for a determination to meet the restriction condition set for each type of content is set to a larger value for a second mode of content than for a first mode of content, and is set to a larger value for a third mode of content than for a second mode of content. Specifically, they are set to have the relationships of A1<B1<C1 and A2<B2<C2. This is because the first mode of content, for example, is content that is not related to any SP user and lets users who are participating communicate with each other, as described above. In contrast, the second and third modes of content are content that is related to any SP user and is not primarily intended to communicate with other users who are participating. Therefore, the first mode of content is set to meet the restriction condition with a smaller number of mutes than the second and third modes of content because the attention to the comments is higher and the impact of the comments on other users is greater in the first mode of content. When focusing on a second mode of content and a third mode of content, it is expected that the number of participants in the content of the third mode will be larger than in the content of the second mode, that the content of the second mode will attract more attention to comments than the content of the third mode, and that the impact of comments on other users will be larger in the second mode of content. Thus, the restriction condition is set to be met with a smaller number of mutes in the second mode of content.

The number of mutes used to determine whether or not the restriction condition is met is calculated taking into consideration the designation frequency for each user. Whether or not a certain user meets the restriction condition may be determined, for example, by calculating the sum of the designation frequencies (values between 0.1 and 1 as mentioned above) of all users who have muted that user, and determining whether or not this sum reaches the number of mutes that meets the restriction condition. Specifically, if there are 50 other users who have designated user A as a mute target, including 10 users with a designation frequency of 0.5 and 10 users with a designation frequency of 0.1, and the remaining users have a designation frequency of 1, then the number of mutes for user A will be 36 (=0.5×10+0.1×10+1×30). If it is determined that this 36 reaches the number of mutes that meets the restriction condition, user A will be determined to meet the restriction condition and will become a target of full mute control.

FIG. 15 describes an example of setting, for each type of content, a first restriction condition for making a determination on the number of mutes during the first period of time and a second restriction condition for making a determination on the number of mutes during a second period of time that is longer than the first period of time. The present invention is not limited to this, and a restriction condition may be set regardless of the type of content, or a restriction condition may be set for one period of time or for each of three or more periods of time.

FIG. 14 and FIG. 15 describe an example of the mute related information and restriction conditions for each user. This information is made visible and identifiable for the operator only through communication with the distribution server 100 via the administrator terminal 200, and no other users can see or identify this information via their user terminals.

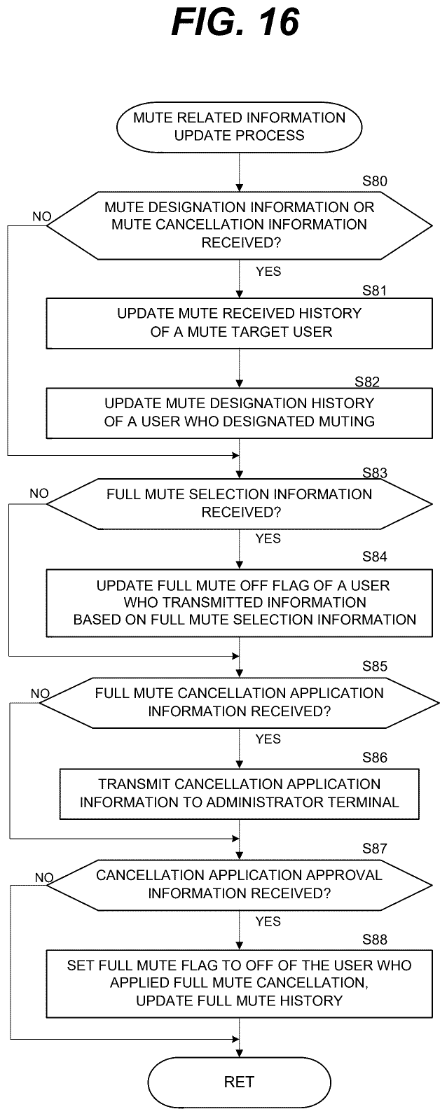

FIG. 16 is a flowchart of a mute related information update process for updating the mute related information. The mute related information update process is repeatedly executed at predetermined time intervals by the controller 130 of the distribution server 100. The distribution server 100 performs the mute related information update process in accordance with a program stored in the storage unit 120.

First, in step S80, the process makes a determination as to whether mute designation information or mute cancellation information has been received from a user terminal. If it is determined that neither the mute designation information nor the mute cancellation information has been received, the process proceeds to step S83. If it is determined that the mute designation information or the mute cancellation information has been received, steps S81 and S82 are performed. For instance, an operation is performed on the user terminal to designate a user as a mute target from the comment history from a user participating in the content, or an operation is performed on the setting screen to search for a user name as a mute target for extraction to designate the user name as a mute target. Thus, mute designation information is transmitted to specify the user designated as the mute target and information to specify the designation user. For instance, an operation is performed on the user terminal to cancel a mute designation for a user participating in the content, or an operation is performed on the setting screen to search for a user name whose mute designation is to be canceled for extraction and cancel the mute designation for the user name. Thus, mute cancellation information is transmitted to specify the user whose mute designation has been cancelled and a user who has designated the cancellation.

If it is determined in step S80 that mute designation information has been received, the process updates the mute-received history information of the user specified from the mute designation information and designated to mute in step S81. That is, the process stores the mute-received history information on the user who was designated as a mute target (i.e., the user designated to mute) that is the current received history, including the user who made a designation (i.e., the designation user who made a mute designation), and the designated date and time. FIG. 8 through FIG. 13H describe the example where reflection of a comment including a NG word is restricted, and the mute-received history information is not updated by the restriction of reflection of the comment including a NG word. In step S82, the process updates the mute designation history information on the designation user who is specified from the mute designation information and who has made a mute designation. That is, the process stores the mute designation history information on the user who made a mute designation (the designation user who made a mute designation) that is the current designation history, including the user as the mute target (the user designated to mute) and the designated date and time.

If it is determined in step S80 that mute cancellation information has been received, the process updates the mute-received history information of the user specified from the mute cancellation information and designated to mute in step S81. That is, the process updates the mute received history information of the user who was designated to mute to be the past received history, including the user who made the mute designation and the date and time of the designation. In step S82, the process updates the mute designation history information on the designation user who is specified from the mute cancellation information and who has requested the cancellation. That is, the process updates the mute designation history information of the user who requested the cancellation including the user who was designated to mute and the date and time of the designation to be those of the past designation history.

In step S83, the process makes a determination as to whether full mute selection information has been received. A user is allowed to use the user terminal to select whether to reflect a comment from a user who is a target of the full mute control without restricting the comment when they are participating in the content or on a settings screen, for example, or to restrict the reflection. Then, full mute selection information is transmitted to specify the user and the selection result. If it is not determined that the full mute selection information has been received, the process proceeds to step S85. If it is determined that full mute selection information has been received, the process proceeds to step S84 to update a full mute off flag of the user who has transmitted the information, on the basis of the full mute selection information. For instance, if the full mute selection information indicating reflection without restriction is received, the process sets the full mute off flag to ON, whereas if the full mute selection information indicating reflection is restricted is received, the process sets the full mute off flag to OFF. In the initial state, the full mute off flag is set to OFF.

In step S85, the process makes a determination as to whether full mute cancellation application information has been received. When viewing their user terminal, a user may feel that their own comment is not being reflected based on reactions from other users, for example, and that they may be a target of full mute control. In this case, the user performs an operation to cancel the full mute control. In response to this operation, the process transmits full mute cancellation application information to apply for cancellation of the full mute control. If it is not determined that the full mute cancellation application information has been received, the process proceeds to step S87. If it is determined that full mute cancellation application information has been received, and if the full mute flag is set to ON for the user who transmitted the full mute cancellation application information in step S86, the process transmits, to the administrator terminal 200, the reception of cancellation application from the user, and cancellation application information for specifying the user's mute received history during the most recent predetermined period of time (e.g., one month), the total comment history received from the user, the full mute history, and others. The total comment history received from the user refers not only to the history of comments posted in the content (including a room) in which the user is participating, but also to the history of all comments posted by the user in various types of content during the most recent predetermined period of time (e.g., one month). Note that the total comment history is also managed by the log management unit 131 described above.

Receiving the cancellation application information, the administrator terminal 200 is able to notify (display) that a cancellation application has been made by a user who is the target of the full mute control, as well as the mute received history, total comment history, full mute history, and other information on the user during the predetermined period of time. As a result, the operator is able to determine whether to cancel the full mute control, taking into consideration the various histories of the user. For instance, if the mute received history and total comment history indicate a change of their attitude, the operator is likely to cancel the full mute control; and the required degree to which the mute received history and total comment history indicate a change of the attitude will be higher the more times they have been muted in the past based on their full mute history. For instance, if the fewer times they have been muted, or the more calm the comments are, it indicates a change of attitude. If the operator performs the operation to cancel, the administrator terminal 200 transmits cancellation application approval information for specifying the user who transmitted the full mute cancellation application information and for whom the full mute control is to be cancelled.

Receiving the cancellation application information, the operator is allowed to view the mute received history, total comment history, and full mute history via the administrator terminal 200. The present invention is not limited to this, and the operator may make a total comment history request to the distribution server 100, and then may be allowed to view the mute received history, total comment history, and full mute history of the designated user. This allows the operator to, for example, forcefully activate full mute control based on the history via the administrator terminal 200. Note that the mute received history, total comment history, and full mute history are visible only to the operator and not to users via their user terminals.

In step S87, the process makes a determination as to whether cancellation application approval information has been received. If it is not determined that the cancellation application approval information has been received, the process ends the mute related information update process. If it is determined that the cancellation application approval information has been received, the process sets the full mute flag of the user specified from this cancellation application approval information (the user who transmitted the full mute cancellation application information and is the cancellation target of full mute control) to OFF in step S88, updates the full mute history (e.g., the number of times full mute control has been performed is added), and ends the mute related information update process.

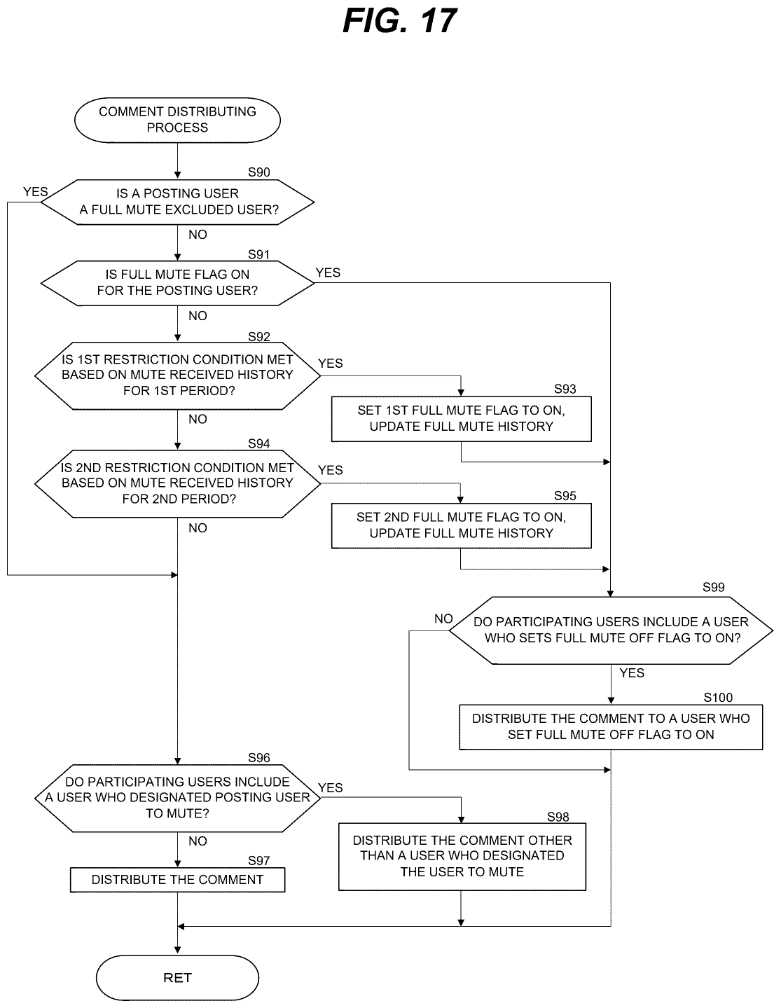

FIG. 17 is a flowchart of the comment distributing process to reflect the mute function and full mute control function when distributing a posted comment to a user terminal. The comment distributing process is executed by the controller 130 of the distribution server 100 when the above-mentioned comment distribution step is performed (or is executed within each comment distribution step). The distribution server 100 performs the comment distributing process in accordance with a program stored in the storage unit 120.

First, in step S90, the process makes a determination as to whether the posting user who posted the comment to be distributed in each comment distribution step is a full mute excluded user. A full mute excluded user is a user who has been set by the operator via the administrator terminal 200 from among SP users, for example, to be excluded from full mute control, regardless of the user's mute received history (even if the history satisfies the restriction condition).

If the user is determined to be a full mute excluded user in step S90, the process proceeds to step S96. If it is not determined in step S90 that the user is not a full mute target user, then in step S91 the process makes a determination as to whether or not the full mute flag for the posting user is set to ON. If it is not determined in step S91 that the full mute flag is set to ON for the posting user, the process makes a determination in step S92 as to whether a first restriction condition is met based on the posting user's mute received history during the first period of time. If it is not determined in step S92 that the first restriction condition is met, the process makes a determination in step S94 as to whether a second restriction condition is met based on the posting user's mute received history during the second period of time. If it is not determined in step S94 that the second restriction condition is met, the process proceeds to step S96.

In step S96, the process makes a determination as to whether users participating in the same content as the posting user (users who can receive comments posted by the posting user) include a user who has designated the posting user as a mute target. Specifically, based on the mute received history (current received history) of the posting user shown in FIG. 14 and the participating user IDs shown in FIG. 6A through FIG. 6C, the process makes a determination as to whether a user who has designated the posting user to mute is included in the same content (or in the same room for a third mode of content).

If it is not determined in step S96 that the users participating in the same content as the posting user include a user who has designated the posting user to mute, the posting user's comment is distributed to the user terminal of each user to which the comment is to be distributed in the comment distribution step. In contrast, if it is determined in step S96 that the users participating in the same content as the posting user include a user who has designated the posting user to mute, the posting user's comment is distributed to the user terminal of each user to which the comment is to be distributed other than a user who has designated the posting user to mute in the comment distribution step. This restricts the reflection of a comment from the posting user on the user terminal of the designation user who has designated the posting user as a mute target.

If it is determined in step S91 that the full mute flag is set to ON for the posting user, the process proceeds to step S99. Even if the full mute flag is not set to ON, if it is determined in step S92 that the first restriction condition is met, a first full mute flag is set to ON as the full mute flag in step S93, and the process proceeds to step S99. If it is determined in step S94 that the second restriction condition is met, a second full mute flag is set to ON as the full mute flag in step S95, and the process proceeds to step S99.

In step S99, the process makes a determination as to whether the users participating in the same content as the posting user include a user who has set the full mute off flag to ON. Specifically, based on the participating user IDs shown in FIG. 6A through FIG. 6C and the setting status of the full mute off flag of the participating users shown in FIG. 14, the process makes a determination as to whether a user who has set the full mute off flag is set to ON is included in the same content (or in the same room for a third mode of content).

If it is not determined in step S99 that users participating in the same content include a user who has the full mute off flag set to ON, then the comment distribution process ends without distributing the comment of the posting user to any user terminal. If it is determined in step S99 that users participating in the same content include a user who has set the full mute off flag to ON, then the process distributes the comment of the posting user to the user terminal of the user who has set the full mute off flag to be ON in step S100. Then, the comment distributing processing ends.

### Example of Specific Configurations and Advantageous Effects Relating to Mute Restrictions

(1) In the above embodiment, in accordance with a program (e.g., a program stored in a non-transitory computer-readable storage medium) stored in the distribution server computer 100 and a user terminal, when a user performs an operation on their user terminal to designate another user as a mute target (a restriction target user), then the distribution server 100 receives mute designation information transmitted from the user terminal. Then, as shown in step S81 of FIG. 16, the mute received history is updated for the designated other user. If a comment is posted from a user who is one of a plurality of users participating in the virtual space of the same content (room) and meets the restriction condition based on the mute received history, and for whom a full mute flag is set to ON, the posting user is considered to be a user who tends to make nuisance comments, and steps S91, S92, S94, and others in FIG. 17 determine YES. Thus, the above embodiment is capable of restricting the reflection of a comment from the posting user basically on the user terminals of a plurality of users participating in the virtual space, including a user who has not designated the user as a mute target. This allows for efficient restriction of harassment and other activities without interfering with free exchange and communication.

(2) In the above embodiment, if the determination result in step S99 is NO in FIG. 17, a comment from a user who meets the restriction condition is not reflected in a plurality of user terminals. This prevents comments from a user who tends to perform nuisance actions from being reflected and adversely affecting other users.

(3) In the above embodiment, a user is allowed to select whether to reflect a comment from a user who is a target of full mute control when participating in the content or using their user terminal displaying the setting screen, or to restrict the reflection of such a comment. Furthermore, in response to the full mute selection information transmitted in response to the selection, as shown in step S84 of FIG. 16, a full mute off flag is updated for the user of the user terminal to specify whether to restrict the reflection of a comment posted by a user whose full mute flag is set to ON and who meets the restriction condition. If a comment posted by a user for whom the full mute flag is set to ON is received, the reflection of the comment is restricted on the user terminal of the user for whom the full mute off flag is set to OFF because the determination result is NO in step S99 of FIG. 17. This allows restriction on the reflection of an action from a user who meets the restriction condition to be set for each user, thereby improving the user's convenience.

(4) The above embodiment determines as to whether or not a user meets the restriction condition, based on the user's mute received history updated for a predetermined period (e.g., a first period, and a second period). This prevents unnecessary restrictions of an action, which may happen if the history in the past before a predetermined period is taken into account and thus the user is still determined to meet the restriction condition, even if they have changed their attitudes and improved their actions.

Furthermore, a first period (e.g., 24 hours) and a second period (e.g., one week) longer than the first period are defined as the predetermined period, and as shown in FIG. 15, a user meets the restriction condition if their mute received history shows that the number of mutes received during the first period reaches a first number, and also if, although the number of mutes within the first period has not reached the first number, the number of mutes within a second period reaches a second number that is greater than the first number. This allows for appropriate restriction because the period of time for the determination of whether or not the restriction condition is met and the number of times the user receives a mute designation are defined in a stepwise manner.

The second period is twice or longer of the first period, and the second number is set to a number less than twice the first number. This allows, even if a user is designated as a mute target to the extent that they are not determined to meet the restriction condition in the first period, the user to be determined to meet the restriction condition when viewed over the longer second period of time, and thus the user may be restricted. This restricts the reflection of a comment from a user who are routinely designated as a mute target over a long period of time.

(5) In the above embodiment, when receiving mute cancellation information from a user terminal to cancel a specific user designated as a mute target, the mute received history for the specific user is updated to the past received history, as shown in step S81 of FIG. 16, and the process makes a determination as to whether the specific user meets the restriction condition based on the current received history of the mute received history, as shown in step S92 through step S95 of FIG. 17. When receiving the mute cancellation information on the user who has been determined to meet the restriction condition, their current received history may be updated to the history that does not meet the restriction condition. Even in this case, the process keeps the determination that the user who has been determined to meet the restriction condition still meets the restriction condition (e.g., even if the determination is YES in step S83 of FIG. 16, their full mute flag is not set to OFF). This allows the determination that the user meets the restriction condition to be kept even after receiving the mute cancellation information, and thus prevents unauthorized cancellation of the restriction condition by the user operation.

(6) In the above embodiment, the log management unit 131 manages the total comment history for each user. For instance, when receiving full mute cancellation application information, the process transmits cancellation application information for specifying the total comment history to the administrator terminal 200 (step S86 of FIG. 16), and may notify (display) the total comment history, for example, on the administrator terminal 200 based on the cancellation application information, so that the operator is able to visually check the history. This allows the operator to understand the total comment history of the user who has applied for cancellation, for example, which can be used to determine whether or not to cancel their full mute control.

(7) In the above embodiment, when receiving mute designation information, the process updates the mute designation history including the designation frequency of the user who transmitted this mute designation information in step S82 of FIG. 16, and determines as to whether the specific user meets the restriction condition based on the designation frequency of a designation user who has designated the specific user as a mute target. This allows for a stronger or weaker influence on a designation as a mute target, depending on the frequency of designation.

(8) In the above, when a comment is received from a user terminal operated by any of the users who are full mute excluded users (special users belonging to a special type) set by the operator from SP users, for example, the process determines YES in step S90 of FIG. 17 on the user terminal of a user who has not designated such a full mute excluded user and among multiple users participating in the same content as a mute target. Thus, the comment is allowed to be reflected on such a user terminal regardless of the mute received history for the full mute excluded user. Meanwhile, the reflection of the comment is restricted on the user terminal of the user who has designated the full mute excluded user as a mute target, in step S98 of FIG. 17. This restricts the reflection of a comment even from a full mute excluded user on the user terminal of the user who has designated the full mute excluded user as a mute target, and thus respects the user's intention and prevents any adverse effects on that user.

(9) In the above embodiment, as shown in FIG. 8 to FIG. 13H, when a comment including a NG word whose reflection is to be restricted is received, the reflection of the comment is restricted regardless of the mute received history of the user who posted the comment. Meanwhile, even if a comment including a NG word is posted and restricted, the mute received history for the user who posted the comment is not updated. This enables the separate management between NG words and mute received history, preventing one from affecting the other and resulting in excessive restrictions.

(10) In the above embodiment, mute related information including updated mute received history and mute designation history is displayed on the administrator terminal 200 so that the operator can check it. However, the information is not displayed on a user terminal 300, so that the user is not able to specify it. This prevents users from specifying the information and abusing it (e.g., designating a specific user as a user to be restricted by multiple users and thus having the user meet the restriction condition by targeting the specific user).

### MODIFICATION EXAMPLES

The following is a list of modification examples and others of the embodiments described above.

(1) The above embodiment describes an example in which a restriction process is performed to restrict the reflection of a comment posted by a user for which a full mute flag is set to ON on a user terminal of a user, except for a user who sets the full mute off flag to ON. However, the restriction process is not limited to restricting all of the comments posted by a user for whom the full mute flag is set to ON. The restriction process may also include restricting the reflection of a comment according to a predetermined ratio. The process of restricting the reflection according to a predetermined ratio may restrict a comment posted by user A for which the full mute flag is set to ON at a ratio of 50%. Specifically, assume that user A posts five comments, such as comments 1 to 5, over time. In this case, when comments 1 to 5 are received, the process may determine whether or not to restrict the reflection of the comments by lottery so as to restrict the reflection at the ratio of 50%. The process may restrict the reflection of comments based on the order so that the ratio is 50%; the reflection of comment 1 is restricted, the next comment 2 is reflected, and the reflection of the next comment 3 is restricted, for example. This thins out comments by a user who meets the restriction condition based on their mute received history, thus preventing all the comments from users who tend to perform nuisance actions from being reflected and thus adversely affecting other users.

Another process of restricting the reflection according to a predetermined ratio may restrict the reflection of comments according to a ratio of 50% when a user posts the same or same type of comments (including comments containing the same or same type of words; hereinafter simply referred to as the same or same type of comments) consecutively during a predetermined period (e.g., one minute). This prevents other users from feeling uncomfortable due to predetermined same or same type of comments being posted consecutively over a predetermined period of time.

(2) The above embodiment describes an example in which the process makes a determination as to whether the restriction condition is met based on the number of designations as a mute target and the designation frequency by the designation user in FIG. 15. The criterion for determining whether the restriction condition is met may be based only on the number of designations as a mute target (one designation is calculated as one mute count regardless of the designation frequency) without taking into account the designation frequency of the designation user. The criterion for determining that the restriction condition is met is not limited to this as long as it includes the number of designations as a mute target. It may be different depending on the full mute history updated in step S88 of FIG. 16, for example, in addition to the number of designations as the mute target. This allows the degree of restriction to be adjusted according to the number of cancellations on the basis of the full mute history. Specifically, the criterion for determining that the restriction condition is met may be set such that the more the number of times of full mute controls performed and then cancelled in the past based on the full mute history, the lower the criterion is defined so that the restriction condition is met with a smaller number of designations as the mute target (number of mutes) (e.g., the more the number of cancellation, the lower the value of A1 to C2). This allows the restriction condition to be established so that the more the number of cancellation, the smaller number of mutes are required to establish the restriction condition to be a target of full mute control.

(3) The above embodiment describes an example in which the user character of each user participating in the content is placed in a virtual space, making it possible to understand the user character of the user participating in the content. The user characters to be placed include not only a user character of a user who is not the target of the full mute control, but also a user character of a user who is the target of the full mute control. This does not allow users to determine whether they become the target of full mute control, based on their user characters being placed or not, thus making it difficult for the users to find that they meet restriction condition and the reflection of their comments is restricted. If a user who is a target of full mute control meets another condition (e.g., meets a prohibition condition), the user character of that user may not be placed in the virtual space and may not be displayed.

(4) The above embodiment describes an example in which the comment distributing process shown in FIG. 17 is performed based on mute related information stored for each user (e.g., history stored across multiple pieces of content). In another example, receiving mute designation information from a participating user associated with a certain type of content (hereinafter referred to as content A), the process may update the mute related information for content A, and perform the comment distributing process for the content A on the basis of the updated mute related information. That is, mute related information may be managed for each type of content, so that, for example, mute control or full mute control for content A is performed based on the mute related information updated for content A. Content A may be consecutively performed. In this case, mute control or full mute control in such content A may be performed on the basis of the mute related information updated in such consecutively performed content A. This allows the mute received history of a specific user designated by mute designation information from a user associated with the common content to be instantly updated, and also prevents a comment from the specific user from being reflected on the user terminal of the user who designated the specific user as a mute target. Furthermore, the process is able to determine whether or not the restriction condition is met for users participating in the same content, thereby increasing the effectiveness of mute and full mute control.

The above embodiment shows an example, in which users who have a specific relationship are participating users (users who participate in a group of certain content) associated with common content (group), and a full mute flag is set to ON on the basis of the mute received history stored for each user. In another example, the full mute flag may be set to ON on the basis of the number of mutes designated as a mute target from the participating users associated with the common content. Mute control may also be based on a mute target designation from participating users associated with common content.

Users having a specific relationship may be all currently logged-in users. In this case, a full mute flag may be set to ON on the basis of the number of mutes designated as a mute target from the all currently logged-in users. Mute control may also be based on mute target designations from all currently logged-in users.

In content in which a user character corresponding to a user placed in the virtual space is moved in response to the user's operation, users having a specific relationship may be users whose user characters are placed within a predetermined range. In this case, a full mute flag may be set to ON on the basis of the number of mutes designated as a mute target by users whose user characters are placed within a predetermined range. The predetermined range may be, for example, within a circle with a radius of 10 m in the virtual space, or a range that changes from time to time to include a specified number of users (e.g., 20 or 100), or may be defined differently depending on the type of content or virtual space. This allows the reflection of a comment to be restricted among users who are participating in the same content and whose user characters are placed within a predetermined range, thereby preventing the restriction range from becoming too large. The mute control may also be based on the mute target designations from users whose user characters are placed within the predetermined range.

(5) The above embodiment describes an example of a step of performing a process to enable restricting the reflection of a comment from a user who has been designated by another user as a mute target or from a user who meets the restriction condition. In this example, as shown in FIG. 17, the distribution server 100 does not distribute a comment from a user designated as a mute target to a user who has designated this user as a mute target, and a comment from a user who meets the restriction condition is not distributed not only to a user who has designated this user as a mute target but also to a user who has not designated this user as a mute target. In another example, the distribution server 100 may be configured so that a comment from a user who does not meet the restriction condition is uniformly distributed to multiple users including a user who has designated the user as a mute target, and the distributed comment is not displayed on the user terminal of the user who has designated the user as a mute target, and so that only a comment from a user who meets the restriction condition is not distributed to not only a user who has designated the user as a mute target but also a user who has not designated. Then, the distribution server 100 may distribute information that can identify that the comment is from a user who meets the restriction condition so that the user terminal does not display the distributed comment in accordance with the setting of the user terminal (e.g., the state of full mute off flag).

(6) The above embodiment describes an example in FIG. 5 in which multiple types of content (rooms) are provided, and mute control or full mute control is performed for all types of the content. In another example, at least one of mute control and full mute control may not be performed on special type of content among multiple types of content. Special type of content may be, for example, content that has been set by an administrator or creator (organizer) to be exempt from muting, or predetermined content that is not primarily intended to facilitate communication with other participating users (e.g., talent content or celebrity content of the second mode, or live content of the third mode). This allows the adjustment for the effective use or disabling of mute in accordance with the content.

(7) In the above embodiment, as shown in FIG. 17, if the restriction condition is met, the user automatically becomes a target of full mute control. The present invention is not limited to this. The process distributes information that the restriction condition has been met, as well as information to specify the user's mute related information, total comment history, and other types of information to the administrator terminal 200, and the operator may review the information and decide whether or not to make the user a target of full mute control. When participating in any content other than the specific content among multiple types of content, if a user meets restriction condition, they will automatically become a target of full mute control. When participating the specific content, the process may distribute information that the restriction condition has been met, as well as information to specify the user's mute related information, total comment history, and other types of information to the administrator terminal 200, and the operator may review the information and decide whether or not to make the user a target of full mute control. The specific content may be, for example, content that has been set by the administrator or creator (organizer) to be a target of full mute control or at the discretion of the operator, or predetermined content (e.g., the first mode of content) that is primarily intended to facilitate communication with other participating users. This allows the initiation trigger for full mute control to be adjusted according to the content.

(8) The above embodiment describes an example in which the process makes a determination as to whether the full mute flag is set to ON while the user is participating in content, as shown in step S91 of FIG. 17. The present invention is not limited to this. For a user whose full mute flag is set to ON, the process may confirm that the full mute flag is set to ON at the timing of their logging in or participating in any content, and thereafter, when a comment is posted from that user, the process may proceed to step S99 without making the determination in step S91. This reduces the processing load.

(9) The above embodiment describes an example, as shown in FIG. 16, in which a full mute flag is cancelled at the discretion of the operator. In another example, the condition for cancelling a full mute flag may be automatically met: when the user exits content for which the full mute flag is set to ON; when the day after the full mute flag is set to ON arrives (when the date is crossed); when a predetermined period of time (e.g., 24 hours) has elapsed since the full mute flag is set to ON; or when the user has participated in any content for a predetermined period of time since the full mute flag is set to ON.

The above embodiment describes an example, in which the reflection of a comment from a user who has been designated as a mute target or a user for whom the full mute flag is set to ON is restricted. The present invention is not limited to this, and even if a comment is from a user designated as a mute target or a user for whom the full mute flag is set to ON, if the comment contains a specific word, it may be reflected on the user terminals of all users. For instance, the specific word may be a catchphrase of a SP user or a word indicating a one-liner joke, or may be a word preset by the operator.

(10) The above embodiment describes an example in which when a SP user newly participates in the virtual space of a first type of content, if the NG word (e.g., individual NG, type-specific NG) set for the SP user is included in step S13 of FIG. 8, the comment including the NG word is deleted from the comment history, and the comment history information to specify the updated comment history is output in step S12. The present invention is not limited to this. When a SP user newly participates in the virtual space of the first mode content, the comment history may be updated according to the type of a NG word set for the SP user so that the comment corresponding to the action belonging to a first type is kept, while the comment corresponding to the action belonging to a second type is deleted. For example, among the NG words set for the SP user, a type-specific NG word set for the type of the SP user may be defined as a first type of NG word, and an individual NG word set individually by the SP user may be defined as a second type of NG word. Then, when the SP user newly participates in the virtual space of the first mode of content, a comment including the type-specific NG word of the first type may be kept, while a comment including an individual NG word of the second type may be deleted to update the comment history, and the comment history information for specifying the updated comment history may be output. This makes it possible to more precisely determine whether to reflect or restrict a comment in accordance with the types of NG word when a SP user newly participates in the virtual space of the first mode of content. Note that the first type of NG words and the second type of NG words are not limited to this example. For example, when setting NG words, a first rank or a second rank may be set for each NG word depending on the meaning of the word, and NG words set to the first rank may be defined to be NG words of the first type, and NG words set to the second rank may be defined to be NG words of the second type.

(11) The above embodiment describes an example, in which users who participate in a group of content that the users are allowed to view and experience the content are users who have a specific relationship. The present invention is not limited to this. A virtual space or user characters are not displayed, and for example, users who participate in a message exchanging group (e.g., a group chat, and a mailing list) set up so that messages can be exchanged between multiple people may be users who have a specific relationship.

(12) The above embodiment describes an example, in which the distribution server 100 restricts the reflection of an individual NG word set for a SP user, whereas it does not set and restrict a NG word for each of general users who are not SP users. Also for general users who are not SP users, the distribution server 100 may set a NG word for each general user upon request from the general user to set the NG word. In this case, the distribution server 100 may restrict the reflection of such a NG word for each general user only within a host room (virtual space) that is relevant to the general user, such as a room opened (hosted) by the general user themselves, and in which other users (e.g., friend users) are able to participate. This prevents excessive restriction of such a NG word set for the general user even when the word is not relevant to the general user.

(13) As shown in step S18 of FIG. 8, step S35 of FIG. 10, step S57 of FIG. 12, and others, in the above embodiment, based on the NG-related information in FIG. 7C, it is determined whether the user who posted the comment is a user who satisfies the prohibition condition for the type (hereinafter, SP1) of the related SP user. If the user is a user who satisfies the prohibition condition (hereinafter referred to as a prohibited user), the reflection of a comment posted by the prohibited user is restricted, regardless of whether the comment contains a NG word, and regardless of whether a SP user who caused the prohibition condition to be satisfied (e.g., a SP user, with respect to which the number of restriction has reached a predetermined number of times, hereinafter referred to as a prohibition source SP user) is participating. The above embodiment describes an example in which, when a related SP user who is related to the content that the prohibited user is viewing and experiencing is a user of a different type (hereinafter, SP2) from the type that satisfies the prohibited condition, the reflection of a comment posted by the prohibited user will not be restricted simply by satisfying the prohibition condition. In this case, it may be possible to notify a related SP user of SP2 who is related to the content that the prohibited user is viewing/experiencing of the information that enables identification of the prohibition source user who caused the prohibition condition to be satisfied (e.g., the distribution server 100 may output information to display a message on the user terminal of the related SP user, such as “This user has reached a predetermined number of NG actions against a prohibition source SP user belonging to SP1”). It may be also possible to notify a related SP user of SP2 who is related to the content that the prohibited user is viewing/experiencing of the information that enables identification of the NG word, about which the prohibited user has satisfied the prohibition condition and whose reflection is restricted (e.g., the distribution server 100 may output information to display a message on the user terminal of the related SP user, such as “This is the NG word that the prohibition user has posted). This calls the attention of the related SP user of SP2.

If the above-mentioned prohibited user participates in content with which a related SP user of SP2 is related and posts the NG word, and thus satisfies the prohibition condition for the related SP user of SP2. Then, the prohibited user may satisfy prohibition conditions for a predetermined number or more (e.g., two, three, and more) of types. In this case, it also may be possible to restrict the reflection of a comment posted by the prohibited user in content that is related to a related SP user of a type with respect to which the prohibited user does not satisfy the prohibition condition. This identifies a user as being clearly malicious if the user satisfies prohibition conditions for the predetermined number or more of types, and prevents this prohibited user from posting comments, regardless of the type of related SP user, thus preventing the damage from spreading.

It may also be possible to cancel (e.g., reset the number of restrictions) the prohibition condition satisfied by the prohibited user, in response to an operation from the prohibition source user who caused the prohibition condition to be satisfied or from the operator. This prevents a situation in which the prohibited user satisfies the prohibition condition continuously, and thus the comment posting from this prohibited user is continuously restricted.

(14) The above embodiment describes an example, in which an individual NG word can be set based on a request to set the NG word in response to an operation from a SP user, while the default type-specific NG word for each type of SP user cannot be changed. This allows an individual NG to be customized according to the SP user's intention, thus improving the convenience. Whereas, this does not allow a type-specific NG to be changed, thus making it easier for the operator to manage the level of restrictions on the type-specific NG. The present invention is not limited to this, and a default type-specific NG type that is a default for each type of SP users may also be set for each SP user in response to an operation from the SP user. In this case, for example, the operator sets a type-specific NG as default for each type of SP users, and uniformly reflects it as the default NG information for each SP user (e.g., storing this type-specific NG in association with information on each user as in FIG. 7C), and thereafter not only individual NG but also type-specific NG stored in association with the information on each user may be customized (e.g., to exclude from the restriction), based on a request to set NG words in response to an operation by the SP user. This allows a SP user to customize not only individual NG but also type-specific NG according to their intention, thus improving convenience.

(15) The above embodiment exemplifies comment posting that is an action that a user can take and that is to be restricted. The actions that a user can take and that are to be restricted (e.g., NG word restriction, mute restriction, and full mute restriction) are not limited to this, and instead of or in addition to this, examples of the actions include: actions of changing the position, orientation, and tilt of a virtual camera that is placed in the virtual space and can be operated by the user; actions of changing decorative objects (e.g., costume objects) of the user character placed in the virtual space; actions of emoting; actions of discarding owned objects; and actions of providing money, game value, or rewards, which may be set as appropriate.

Among the actions of changing the position, orientation, and tilt of a virtual camera, the actions to be restricted include: restricting the entry position of the virtual camera to outside a specified range (stage); and restricting the orientation to a specified orientation. Among the actions of changing the decorative objects (e.g., costume objects) of a user character to be placed in the virtual space, the actions to be restricted include: changing to a costume object that stands out more prominently than the content distributor or changing to a costume object that is more revealing.

Among the actions of emoting, the actions to be restricted include attacking a fallen user object, or repeating the same action. Among the actions of discarding an owned object, the actions to be restricted include discarding an object provided by a SP user within content in which the SP user is a related SP user. Among the actions of providing money, gaming value, or rewards, the actions to be restricted include providing a reward to only one SP user in the content in which multiple SP users participate. Note that the actions to be restricted are set by a user as appropriate, as in the above embodiment, and thus are not limited to these.

(16) The above embodiment shows an example of satisfying the prohibition condition in step S25 of FIG. 8, that is the number of times that a NG word has been posted to a SP user has reached a predetermined number. The present invention is not limited to this as long as it is determined based on NG-related information. For instance, a rank of the NG word (e.g., one NG word that satisfies the prohibition condition when it is posted once or another NG word that satisfies it when it is posted three times) may be set based on the degree of influence, and whether or not the prohibition condition is satisfied may be determined based on other parameters such as the NG-related information and the rank. In addition, the above embodiment shows an example, in which whether or not the prohibition condition is satisfied is determined based on NG-related information for one SP user. The present invention is not limited to this. It may be determined based on NG-related information on SP users of the same type (e.g., determined based on the total number of NGs for SP users of SP1) or based on NG-related information on all SP users regardless of their type (e.g., determined based on the total number of NGs for all SP users).

The above embodiment describes an example in which if a type-specific NG or individual NG is included in step S17 of FIG. 8, in step S43 of FIG. 10, or in step S65 of FIG. 12 and others, NG-related information is updated in step S24. The present invention is not limited, and only if a type-specific NG or individual NG is included in step S17 of FIG. 8, NG-related information is updated in step S24.

(17) The above embodiment describes an example, in which it is determined in step S17 of FIG. 8, for example, whether or not the NG word that has been set is included. When determining whether or not the NG word is included, a determination may be made as to whether the NG word that has been set is included as it is, or instead of or in addition to this, a determination may be made as to whether a word related to the NG word that has been set (an action related to the set action) is included. A word related to the set NG word may include a word that partially match the set NG word, a word that has the same meaning as the set NG word, a word that has an inflected form of the set NG word (e.g., a word that is a five-tier conjugation), and a word that does not matter whether they are double-byte and single-byte characters.

(18) The above embodiment describes an example, in which the distribution server 100 is capable of providing content of the first to third modes. The present invention is not limited to this, and the distribution server 100 may be capable of providing content of any one mode, or of providing content of two modes, or of providing content of another mode as well.

The above embodiment describes an example, in which during distribution of any one of the first modes of content, when a SP user, who did not participate, participates in the content, the reflection of a NG word set for the SP user is restricted. In this case, when such a SP user who had been participating has left, the restriction on the reflection of the NG word set for the SP user may be lifted. In addition, assuming a temporary exit of the SP user, the restriction on the reflection of the NG word set for the SP user may be continued. In this case, the restriction on the reflection of a NG word set for the SP user may be continued until a predetermined period of time (e.g., five minutes) has elapsed since the SP user's exit, and the restriction may be lifted after the predetermined time has elapsed.

The above embodiment describes an example, in which during distribution of either a second or third mode of content, the reflection of a NG word set for a related SP user is restricted regardless of whether the related SP user is participating or not. Here, even if the related SP user leaves after participating, the restriction on reflecting the NG word set for the related SP user may continue. If the related SP user has left, the restriction on the reflection of the NG word set for the related SP user may be lifted. In this case, the restriction on the reflection of a NG word set for the related SP user may be continued until a predetermined period of time (e.g., five minutes) has elapsed since the related SP user's exit, and the restriction may be lifted after the predetermined time has elapsed.

### Examples of Software Implementation

The various control blocks of the controller of a computer such as a server or terminal in the above-mentioned embodiments may be implemented by a logic circuit (hardware) formed in an integrated circuit (IC chip), or may be implemented by software using a central processing unit (CPU). When the control blocks are implemented by software using a CPU, the computer having the controller includes a CPU that executes the instructions of a program, which is software that implements various functions, a read only memory ROM) or storage device (these are referred to as “recording media”) in which the program and various data are recorded so as to be readable by the computer (or CPU), and a random access memory (RAM) in which the program is expanded. Then, when the computer (or CPU) reads and executes the program from the above recording medium, the aim of the present invention is achieved. The recording medium may be a “non-transitory tangible medium” such as a tape, a disk, a card, a semiconductor memory, or a programmable logic circuit. The program may be supplied to the computer via any transmission medium (e.g., a communication network or broadcast waves) capable of transmitting the program. One aspect of the present invention can also be implemented in the form of a data signal embedded in a carrier wave, in which the above program is embodied by electronic transmission.

The embodiments disclosed in this description are to be considered in all respects as illustrative and not restrictive. The scope of the present invention is defined by the claims, rather than the above description, and is intended to include any modification within the meaning and scope equivalent to the terms of the claims.

### REFERENCE SIGNS LIST

1 Communication system, 2 Network, 100 Distribution server, 200 Administrator terminal, 300 User terminal, 400 Distribution user terminal

What is claimed is:

1. A method that makes a computer execute to allow an action received from a plurality of user terminals operated by a plurality of users who have a specific relationship to be reflected on the user terminals so that each user is able to recognize the action, the method comprising:
receiving restriction information for designating a specific user as a restriction target user from a user terminal, thereby updating a restriction history on the specific user; and
when an action is received from a user terminal operated by a user who meets a restriction condition on a basis of the restriction history, among the plurality of user terminals operated by the plurality of users having the specific relationship, performing a process to enable restriction of reflection of the action on the plurality of user terminals, including a user terminal operated by a user who has not designated the user who meets the restriction condition as a restriction target user.

2. The method according to claim 1, wherein the performing a process to enable restriction includes not reflecting the action from the user who meets the restriction condition on the plurality of user terminals.

3. The method according to claim 1, wherein the performing a process to enable restriction includes not reflecting the action from the user who meets the restriction condition on the plurality of user terminals in accordance with a predetermined ratio.

4. The method according to claim 3, wherein the action that is a target of the process of not reflecting on the plurality of user terminals in accordance with a predetermined ratio includes a predetermined identical action that is received from the user who meets the restriction condition consecutively over a predetermined period of time.

5. The method according to claim 1, further comprising:
in accordance with information from a user terminal for setting whether to restrict reflection of an action from a user who meets the restriction condition, storing setting information in a storage unit, the setting information corresponding to a user of the user terminal and being for specifying whether to restrict reflection of an action from the user who meets the restriction condition, wherein
the performing a process to enable restriction includes, when an action is received from a user terminal operated by a user who meets the restriction condition, performing a process to enable restricting reflection of the action on a user terminal operated by a user who has specified to restrict reflection of an action from the user who meets the restriction condition in accordance with the setting information stored in the storage unit.

6. The method according to claim 1, wherein whether or not to meet the restriction condition is determined on a basis of a restriction history that is updated for a predetermined period in the updating.

7. The method according to claim 6, wherein the predetermined period includes a first period and a second period longer than the first period, and
the restriction condition is met on a basis of the restriction history when the number of times restriction information is received within the first period reaches a first number, and is also met when the number of times restriction information is received within the second period reaches a second number that is greater than the first number even if the number of times restriction information is received within the first period has not reached the first number.

8. The method according to claim 7, wherein the second period is twice or longer the first period, and
the second number is a number less than twice the first number.

9. The method according to claim 1, wherein
the updating includes, from a user who has transmitted restriction information for designating a specific user as a restriction target user, receiving cancellation information for cancelling the designation of the specific user as a restriction target user, thus updating a restriction history on the specific user,
the performing a process to enable restriction includes
determining whether a restriction condition is met on a basis of the restriction history, and
the determining includes
when receiving cancellation information on a user who has been determined to meet the restriction condition on a basis of the restriction history, and also when the restriction history is updated so as not to meet the restriction condition, keeping a determination that the user who has been determined to meet the restriction condition still meets the restriction condition.

10. The method according to claim 1, further comprising:
when a cancellation condition on a user, the user being a restriction target by the performing a process to enable restriction, is met, cancelling restriction by the performing a process to enable restriction on the user,
the updating includes updating a cancellation history on the user whose restriction has been cancelled in the cancelling, and
a criterion for determining whether the restriction condition is met varies in accordance with a cancellation history of each user.

11. The method according to claim 10, further comprising:
updating an action history for specifying an action received from a user terminal for each user; and
notifying the action history so that the action history is visible to an operator.

12. The method according to claim 1, wherein the updating includes receiving the restriction information, and thus updating a transmission history of the restriction information from the user who has transmitted the restriction information, and
whether or not the restriction condition is met is determined on a basis of a transmission history of the user who has designated a specific user as a restriction target user.

13. The method according to claim 1, further comprising:
displaying specifying information that enables specification of a plurality of users having the specific relationship, and also enabling display of specifying information that enables specification of a user who meets the restriction condition.

14. The method according to claim 1, wherein the performing a process to enable restriction includes, when an action is received from a user terminal operated by any special user belonging to a special type, performing a process to enable reflection of the action on a user terminal operated by a user who has not designated the special user among a plurality of users having the specific relationship as a restriction target user, regardless of a restriction history on the special user, and performing a process to enable restricting reflection of the action on a user terminal operated by a user who has designated the special user as a restriction target user.

15. The method according to claim 1, wherein the performing a process to enable restriction includes, when a restriction target action that is set as an action to restrict reflection is received, performing a process to enable restricting reflection of the action on a plurality of user terminals operated by a plurality of users having the specific relationship, regardless of a restriction history on the user who has performed the action, and
even when the restriction target action is received, the updating does not include updating the restriction history on the user who has performed the restricted action.

16. The method according to claim 1, wherein the specific relationship is a relationship associated with a common group, and
the updating includes receiving restriction information from a user in the common group, and thereby updating a restriction history in the group on a specific user designated by the restriction information.

17. The method according to claim 1, wherein the updating is performed so that information specifying a user who has designated a restriction target user and information specifying a user designated as a restriction target, both pieces of the information being on a basis of the updated restriction history, are set unidentifiable for the plurality of users.

18. A system that comprises a computer and allows an action received from a plurality of user terminals operated by a plurality of users who have a specific relationship to be reflected on the user terminals so that each user is able to recognize the action, the computer performing a process comprising:
receiving restriction information for designating a specific user as a restriction target user from a user terminal, thereby updating a restriction history on the specific user; and
when an action is received from a user terminal operated by a user who meets a restriction condition on a basis of the restriction history, among the plurality of user terminals operated by the plurality of users having the specific relationship, performing a process to enable restriction of reflection of the action on the plurality of user terminals, including a user terminal operated by a user who has not designated the user who meets the restriction condition as a restriction target user.
